(19) United States
(12) Patent Application Publication
(10) Pub. No.: US 2005/0281610 A1
(43) Pub. Date: Dec. 22, 2005

(54) Composite link

(76) Inventors: Barry L. MacLean, Mettawa, IL (US); Jiri J. Pazdirek, Schaumburg, IL (US); Thomas M. Pazdirek, Troy, MI (US)

Correspondence Address: Dana Andrew Alden;MacLean-Fogg Company, 1000 Allanson Road, Mundelein, IL, 60060, US

(21) Appl. No.: 11/154,616

(22) Filed: Jun. 16, 2005

Related U.S. Application Data
(63) Continuation-in-part of application No. 10/861,050, filed on Jun. 4, 2004.

(51) Int. Cl. F16C 11/06

(52) U.S. Cl. 403/56

(57) ABSTRACT

A composite link comprising a coupling member and an attachment. The coupling member includes a composite element, a first end, a second end, and a stem that is located between the first and second end. The first end is provided with an arm. The composite element includes a side that is provided with at least one extension that forms the arm on the first end. The attachment is provided with an axis and an outer surface that extends about the axis. The first arm wraps at least partially about the outer surface of the attachment and secures the attachment to the coupling member.

This application is a continuation-in-part of prior application Ser. No. 10/861,050, filed Jun. 4, 2004, the disclosure of which is hereby incorporated herein by reference.

### FIELD OF THE INVENTION

The present invention pertains to composite links. In the most preferred form, the invention pertains to composite links that include at least one ball joint.

### BACKGROUND OF THE INVENTION

The present invention relates to composite links, such as composite links that include a composite stem that is connected to one or more attachments, such as an attachment for a ball joints. Typically, the composite stem is connected to the attachment via crimping or gluing.

### SUMMARY OF THE INVENTION

The scope of the present invention is defined solely by the appended claims, and is not affected to any degree by the statements within this summary. Briefly stated, a composite link embodying features of the present invention comprises a coupling member and an attachment. The coupling member includes a composite element, a first end, a second end, and a stem that is located between the first and second end. The first end is provided with an arm. The composite element includes a side that is provided with at least one extension that forms the arm on the first end. The attachment is provided with an axis and an outer surface that extends about the axis. The first arm wraps at least partially about the outer surface of the attachment and secures the attachment to the coupling member.

### BRIEF DESCRIPTION OF THE DRAWINGS

FIG. 1 depicts a cross-sectional view of the preferred embodiment of the composite link.

FIG. 2A depicts a sheet of composite material that is included in a plug of the preferred embodiment.

FIG. 2B depicts a close up view sectional view of the plug of the preferred embodiment.

FIG. 3 depicts a perspective view of a coupling member of the preferred embodiment.

FIG. 4 depicts a cross-sectional view of a coupling member of the preferred embodiment.

FIG. 5A depicts a perspective view of a coupling member of the preferred embodiment.

FIG. 5B depicts a perspective view of a coupling member of the preferred embodiment.

FIG. 6 depicts a sectional view of the coupling member and the attachments of the preferred embodiment.

FIG. 7A depicts a sectional view of the coupling member and the attachments of the preferred embodiment.

FIG. 7B depicts the coupling member and attachments after being cured in a mold.

FIG. 8 depicts the composite element and crossing element of the preferred embodiment.

FIG. 9 depicts the core and the crossing element of the preferred embodiment.

FIG. 10 depicts the composite element and the crossing element of the preferred embodiment.

FIG. 11 depicts a perspective view of an attachment of the preferred embodiment.

FIG. 12A depicts a cross-sectional view of an attachment of the preferred embodiment.

FIG. 12B depicts a cross-sectional view of an attachment and a priming strip of the preferred embodiment.

FIG. 13 depicts a profile view of a socket of the presently preferred embodiment.

FIG. 14 depicts a perspective view of a socket of the preferred embodiment.

FIG. 15 depicts a side perspective view of a socket of the preferred embodiment.

FIG. 16 depicts a cross-sectional view of a ball joint, an attachment, and the coupling member of the preferred embodiment.

FIG. 17 depicts a cross-sectional view of a ball stud of an embodiment of the present invention.

FIG. 18 depicts a cross-sectional view of a portion of a ball stud and seal of an embodiment of the present invention.

FIG. 19 depicts a cross-sectional view of a seal of the preferred embodiment.

FIG. 20 depicts a cross-sectional view of a seal of the preferred embodiment.

FIG. 21 depicts a cross-sectional view of a portion of a seal of the preferred embodiment.

FIG. 22 depicts a cross-sectional view of a portion of a seal of the preferred embodiment.

FIG. 23 depicts a cross-sectional view of a portion of a seal of the preferred embodiment.

FIG. 24 depicts a cross-sectional view of a seal of the preferred embodiment.

FIG. 25 depicts a cross-sectional view of a seal of the preferred embodiment.

FIG. 26 depicts the ball stud and seal of an embodiment of the present invention.

FIG. 27 depicts a cross-sectional view of a seal of the preferred embodiment.

FIG. 28 depicts a cross-sectional view of a seal of the preferred embodiment.

FIG. 29 depicts a cross-sectional view of a seal of the preferred embodiment.

FIG. 30 depicts a cross-sectional view of a seal of the preferred embodiment.

FIG. 31 depicts a cross-sectional view of a seal of the preferred embodiment.

FIG. 32 FIG. 16 depicts a cross-sectional view of a ball joint, an attachment, and the coupling member of the preferred embodiment.

FIG. 33 depicts a ball stud of an alternative embodiment.

FIG. 34 depicts a cross-sectional view of a portion a ball stud of an alternative embodiment.

FIG. 35 depicts a cross-sectional view of a portion of a ball stud of an alternative embodiment.

FIG. 36 depicts a cross-sectional view of a portion of a ball stud of an alternative embodiment.

FIG. 37 depicts a cross-sectional view of a portion of a ball stud of an alternative embodiment.

FIG. 38 depicts a cross-sectional view of a portion of a ball stud of an alternative embodiment.

FIG. 39 depicts a cross-sectional view of a portion of a ball stud of an alternative embodiment.

FIG. 40 depicts a cross-sectional view of a portion of a ball stud of an alternative embodiment.

FIG. 41 depicts a cross-sectional view of a ball stud of an alternative embodiment.

FIG. 42 depicts a cross-sectional view of a portion of a ball stud of an alternative embodiment.

FIG. 43 depicts a cross-sectional view of a portion of a ball stud of an alternative embodiment.

FIG. 44 depicts a cross-sectional view of a portion of a ball stud and seal of an alternative embodiment.

### DETAILED DESCRIPTION OF THE PRESENTLY PREFERRED EMBODIMENTS

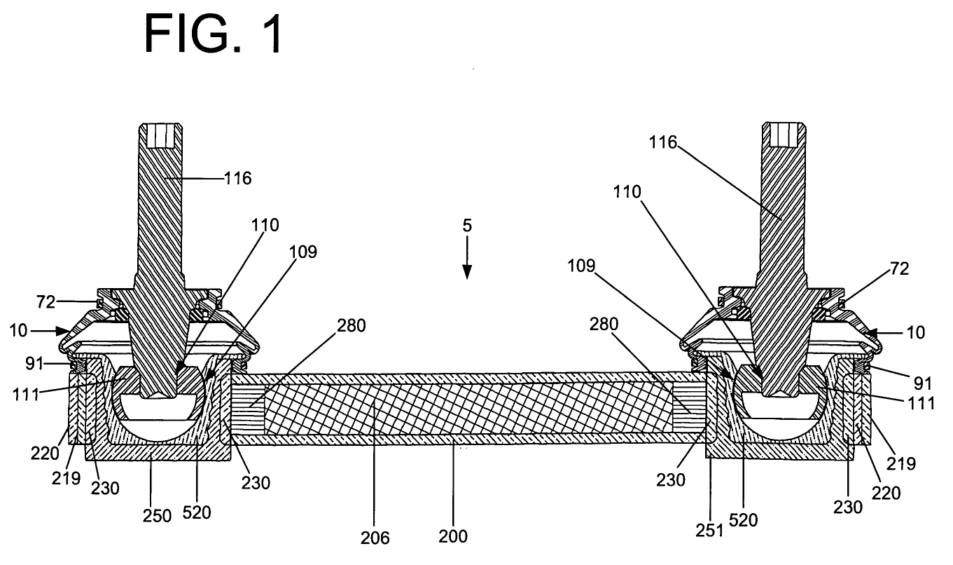

FIG. 1 depicts the composite link 5 of the presently preferred embodiment. As shown therein, the composite link 5 is provided with a coupling member 200.

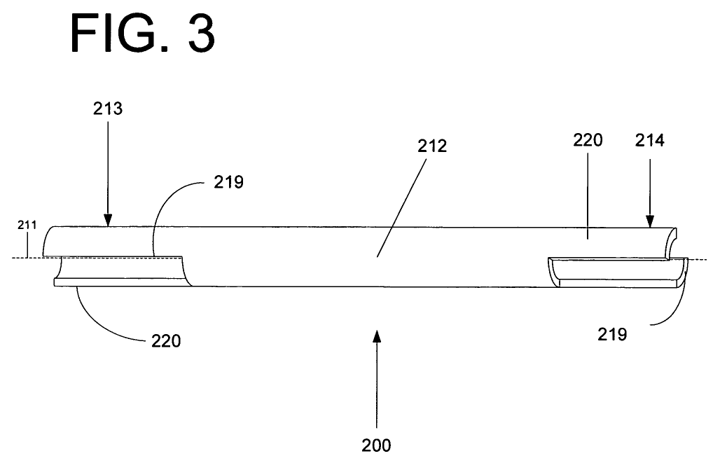

Referring now to FIGS. 3-5B, the coupling member 200 is provided with an axis 211, a stem 212, a first end 213, and a second end 214. As shown in FIG. 3, the stem 212 is generally tubular in shape and located between the first end 213 and the second end 214.

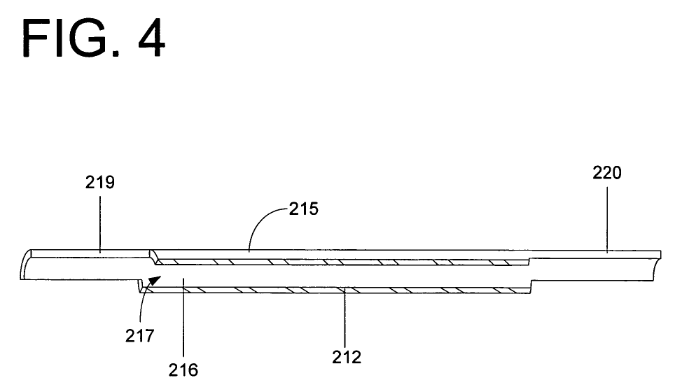

Turning now to FIG. 4, the stem 212 is provided with an outer surface 215 and an inner surface 216 that extend about the axis 211. The outer surface 215 is generally cylindrical in shape; however, in an alternative embodiment, the outer surface 215 can be bent or provided with a frusto-conical shape. The inner surface 216 defines a member cavity 217 that is shaped according to the outer surface 215. FIG. 3 depicts the member cavity 217 provided with a generally cylindrical shape.

Turning back to FIG. 1, within the member cavity 217, a core 206 is located. Advantageously, the core 206 is solid and occupies at least a portion of the member cavity 217. In the preferred embodiment, the core 206 includes a foam material, such as closed cell microsphere foam. The core 206 is preferably pre-formed and pre-cured in a mold prior to being located within the member cavity 217.

Also shown in FIG. 1, in the preferred embodiment, the member cavity 217 is shaped to receive at least one plug 280. Advantageously, at least a portion of the member cavity 217 is shaped according to the plug 280, which, in the preferred embodiment, is generally cylindrical in shape. In the preferred embodiment, first and second plugs 280 are located within the coupling member 200. The first and second plugs 280 secure, at least in part, respective attachments 250, 251 to the coupling member 200.

The plugs 280 of the coupling member 200 are preferably fabricated from a composite material. In the preferred embodiment, the plugs 280 include a polymer and a fiber. The fibers are preferably pre-impregnated with epoxy thermoset resin and are in the form of a sheet that has been cut into a predetermined shape. According to one aspect of the present embodiment, the fiber is a carbon fiber. According to another aspect of the present embodiment, the polymer is an epoxy thermoset resin. In an alternative embodiment, the fiber is a glass fiber. In yet another alternative embodiment, the fiber is an aramid.

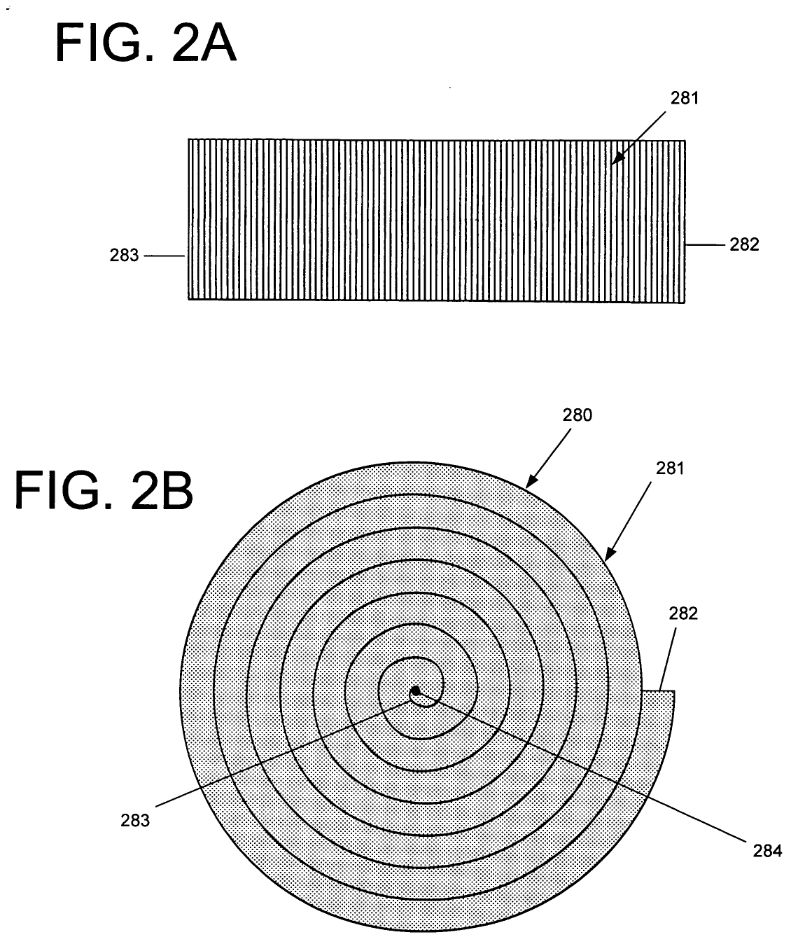

As shown in FIG. 2A, each of the plugs 280 are preferably fabricated from a generally rectangular sheet 281 of composite material that is provided with a first side 282 that opposes a second side 283. In the preferred embodiment, the plugs 280 are formed by rolling the sheet 281 into a generally cylindrical in shape as shown. As shown in FIG. 2B. As shown therein, the plugs 280 are preferably provided with a plurality of overlapping layers that extend about an axis 284 of the plugs 280. The first side 282 is preferably located on an outermost layer of the plug 280 and the second side 283 is preferably located on an innermost layer of the plug 280.

Although the preferred embodiment includes a plug 280 that is fabricated from a composite sheet and a component of the coupling member 200, however, in an alternative embodiment, a plug 280 is fabricated from a plastic, such as a thermoset resin, and formed integrally on the attachments 250, 251 from.

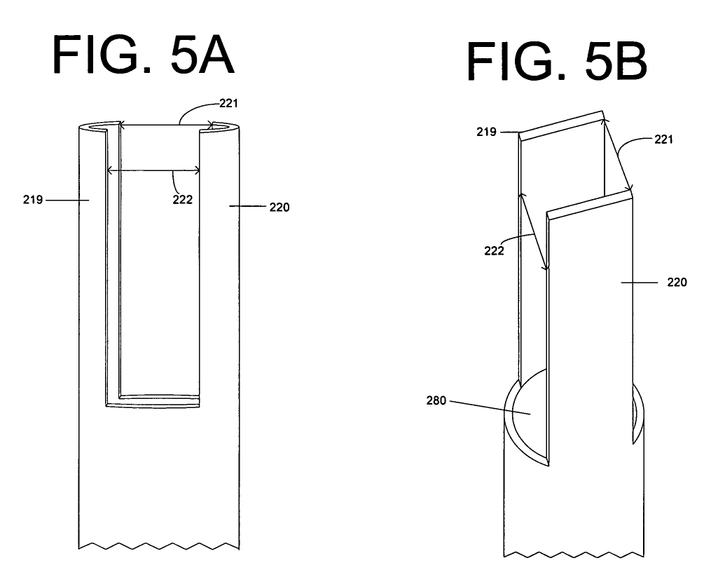

Turning again to FIGS. 3-5B, at least one of the ends 213, 214 of the coupling member 200 is provided with at least one arm, preferably a set of two arms. FIG. 3 depicts each end 213, 214 provided with a set of arms comprising a first arm 219 and a second arm 220. As show best in FIG. 5A, the two arms 219, 220 are formed, at least in part, by a first slot 221 and a second slot 222. The slots 221, 222 are located adjacent to the arms 219, 220 and are shaped according to an outer surface 254 of one of the attachments 250, 251.

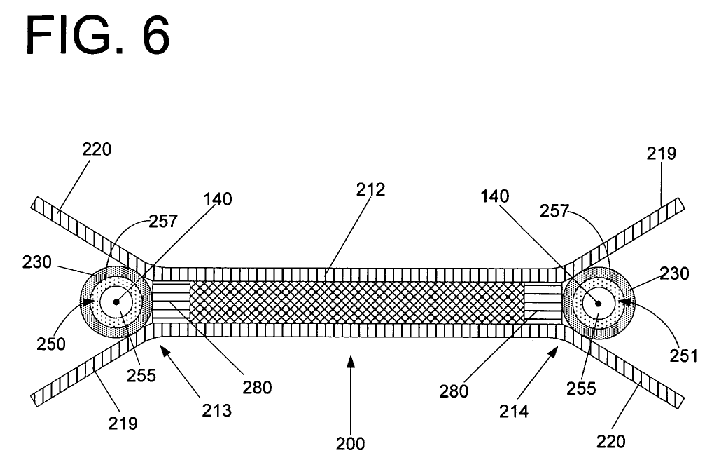

Advantageously, each end 213, 214 is provided with slots 221, 222 that accept one of the attachments 250, 251 while the set of arms 219, 220 is configured to secure the attachment to the coupling member. As Shown in FIG. 5, the arms 219, 220 at the ends 213 of the stem 212 are shaped to be wrapped about the outer surface 254 of one of the attachments 250, 251. As shown in FIG. 6, the arms 219, 220 on the first end 213 are wrapped so that the second arm 220 overlaps at least a portion of the first arm 219. Also shown therein, the arms 219, 220 on the second end 214 are wrapped so that the first arm 219 overlaps at least a portion of the second arm 220. As shown in FIG. 1, after being wrapped, the first and second arms 219, 220 are provided with a generally rectangular cross-sectional profile.

In the preferred embodiment, the coupling member 200 is composed of a composite material. In the preferred embodiment, the coupling member 200 includes a polymer and a fiber. According to one aspect, the fiber is a carbon fiber. According to another aspect, the fiber is a glass fiber. The preferred embodiment includes both carbon and glass fibers and the polymer is an epoxy thermoset resin. In an alternative embodiment, the fiber is an aramid.

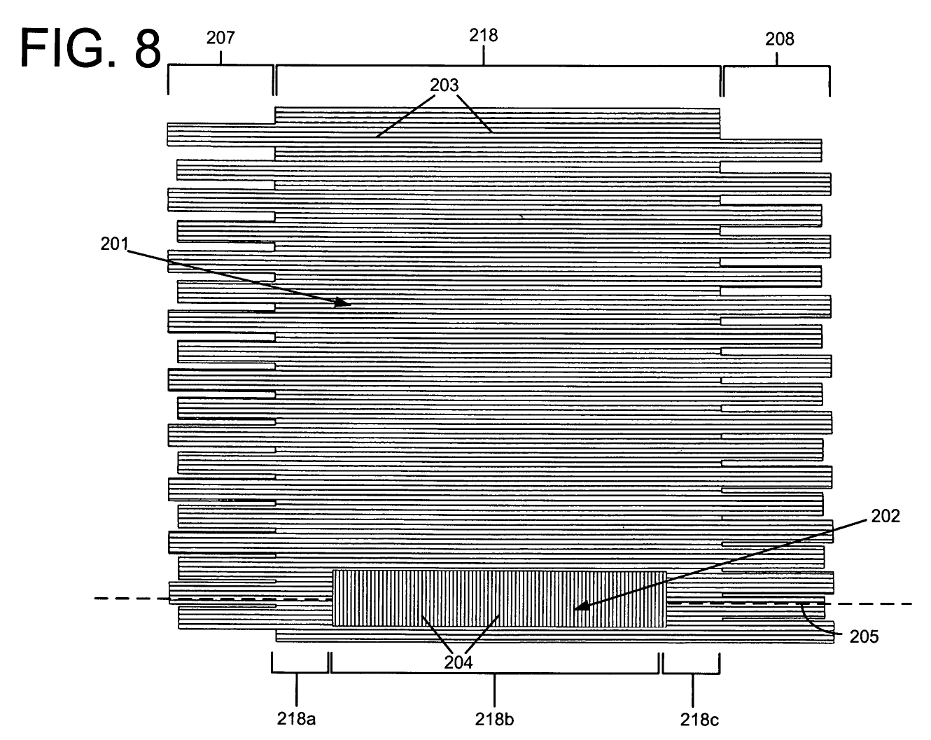

FIG. 8 depicts a plurality of elements that are included in the coupling member 200. As shown therein, the coupling member 200 is fabricated from a composite element 201 and a crossing element 202. The composite element 201 and the crossing element 202 include respective fibers 203, 204 pre-impregnated with an epoxy thermoset resin and are in the form of sheets that have been cut into a predetermined shape. In the preferred embodiment, the composite element 201 and the cross element 202 are each fabricated from a single sheet.

As shown in FIG. 8, the composite element 201 is generally rectangular and provided with a pair of opposing shaped sides designated 207 and 208. The composite element 201 includes a plurality of fibers 203. In the preferred embodiment, the fibers 203 of the composite element 201 are oriented according to the axis 205 of the core 206. The fibers 203 are located an angle, with respect to the axis 205, that ranges from 0° to 90°. In the preferred embodiment, the fibers 203 are oriented so that are generally parallel to the axis 205 whereby they are located at an angle, with respect the axis 205, that measures 0°.

As shown in FIG. 8, the crossing element 202 is generally rectangular and preferably includes a plurality of fibers 204. In the preferred embodiment, the fibers 204 of the composite element 202 are oriented according to the axis 205 of the core 206. The fibers 204 are located an angle, with respect to the axis 205, that ranges from 0° to 90°. In the preferred embodiment, the fibers 204 are oriented so that are generally perpendicular to the axis 205 whereby they are located at an angle with respect the axis 205 that measures 90°.

According to one aspect of the present invention, the crossing element 202 is wrapped about the core 206. According to another aspect of the present invention, the composite element 201 is wrapped about the core 206. In the preferred embodiment, the composite element 201 and crossing element 202 are wrapped about the core 206 in a generally cylindrical manner to provide the coupling member 200 with a plurality of layers. The total number of layers ranges from 9 to 20. The number of layers provided by the crossing element ranges from 1 to 10. In the preferred embodiment, the crossing element forms one layer. The number of layers provided by the composite element ranges from 1 to 10. In the preferred embodiment, the composite element forms 9 layers.

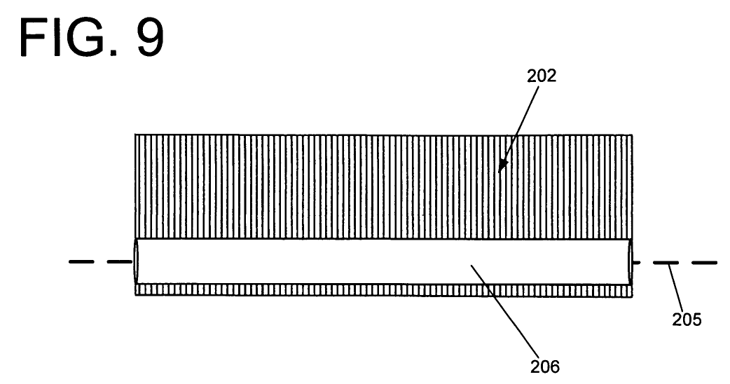

In the preferred embodiment, a first layer is provided by wrapping the crossing element 202 about the core 206. In the preferred embodiment, second, third, fourth, fifth, sixth, seventh eighth, ninth, and tenth layers are provided by rolling the composite element 201 about the crossing element 202 for nine times. As shown in FIG. 9, the crossing element 202 is wrapped around the core 206, and then, as shown in FIG. 8, the composite element 201 is wrapped around the crossing element 202; however, in an alternative embodiment, the composite element 201 is wrapped about the core 206 while the crossing element 202 is wrapped about the composite element 201.

Referring to FIG. 8, the composite element 201 is generally rectangular in shape and provided with a stem defining region 218, a first shaped side 207, and a second shaped side 208. As shown therein, the stem defining region 218 is located between the first and second shaped sides 207, 208.

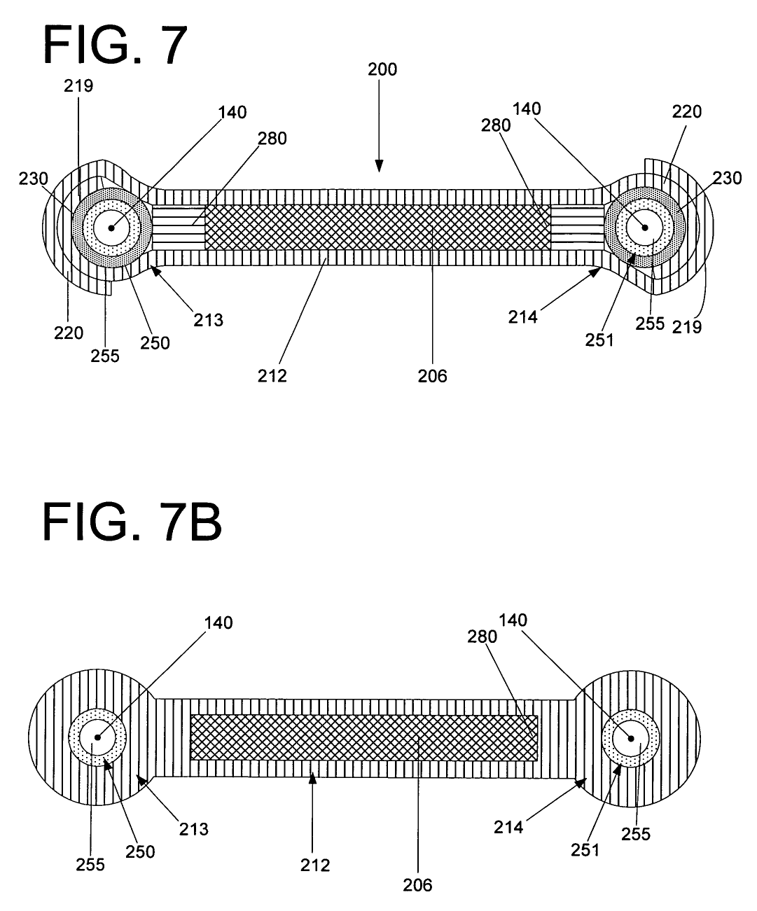

According to one aspect of the present embodiment, the stem defining region 218 cooperates with the crossing element 202 to define the stem 212 of the coupling member 200. As shown in FIG. 8, the stem defining region 218 includes a core receiving portion 218b located between a first plug receiving portion 218a and a second plug receiving portion 218c. The first and second plug receiving portions 218a, 218c are dimensioned to receive plugs 280, shown in FIG. 7A. The core receiving portion 218b is dimensioned to be wrapped around the crossing element 202, as shown in FIG. 8.

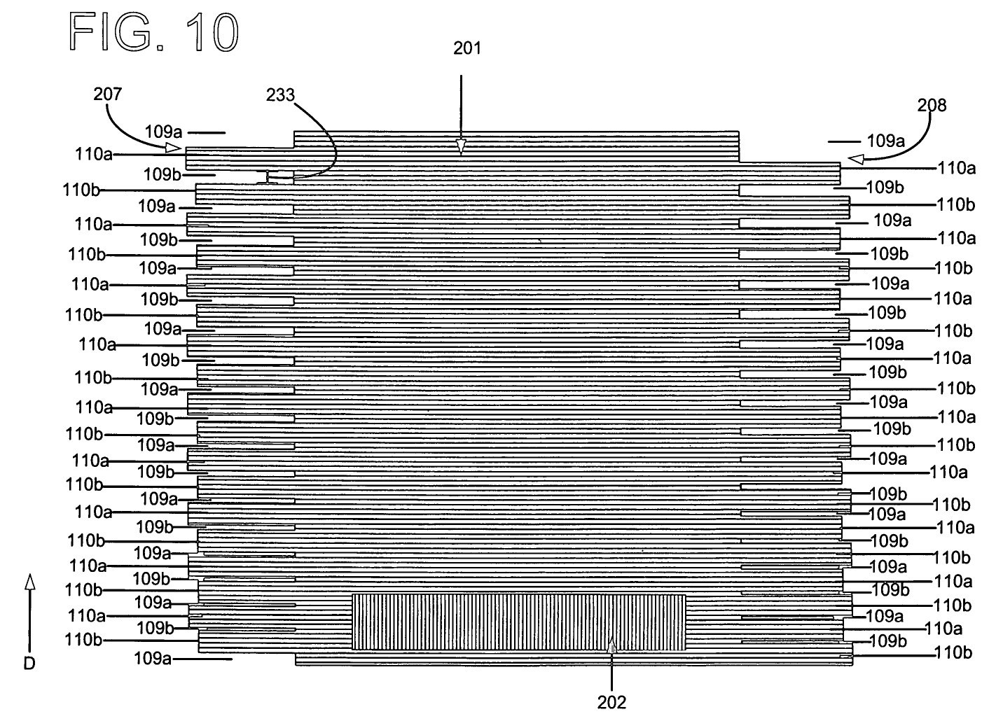

The shaped sides 207, 208 are configured to form the ends 217, 218 of the coupling member 200 once the composite element 201 is wrapped. As shown in FIG. 10, the first shaped side 207 and the second shaped side 208 are preferably provided with a first set of cutouts 209a, a second set of cutouts 209b, a first set of extensions 210a, and a second set of extensions 210b. As shown in FIG. 10, the cutouts 209a, 209b extend along the shaped sides 207, 208 and are provided with a cutout width 233. According to one aspect of the present embodiment, the dimension of the cutout width 233 varies according to the location of the cutouts 209a, 209b along the first and second sides 207, 208. As shown in FIG. 10, the cutout width 233 increases the further the cutouts 209a, 209b extend along the first and second sides 207, 208 in the direction D of wrapping.

The extensions of each set are positioned on the first and second sides 207, 208 to form arms 219, 220 when the composite element 201 is wrapped about the core 206. During rolling, the first set of extensions 210a located on the first side 207 lay on top of one another just as the first set of extensions 210a located on the second side 208 lay on top of one another as well. Similarly, the second set of extensions 210b located on the first side 207 lay on top of one another just as the second set of extensions 210b of the second side 208 lay on top of one another as well. Thus, the first side 207 forms the first end 213 with the first set of extensions 210a on the first side 207 forming the first arm 219 and the second set of overlapping extensions 210b on the first side 207 forming the second arm 220. In similar fashion, the second side 208 forms the second end 214. The first and second sets of overlapping extensions 210a, 210b form the two arms at the second end 214.

The cutouts of each set are formed within the composite element 201 so as to provide the slots 221, 222 when the composite element 201 is rolled about the core 206. During rolling, the cutouts 209a of the first side 207 line up with one another just as the cutouts 209a of the second side 208 line up with one another as well. Similarly, the second set of cutouts 209b of the first side 207 line up when the composite element 201 is rolled about the core 206 just as the extensions 210b of the second side 208 lay on top of one another. Thus, the first side 207 forms the first end 213 with the first set of cutouts 209a, 210a on the first side 207 forming the first slot 221 and the second set of cutouts 209b on the first side 207 forming the second slot 222. In similar fashion, the second side 208 forms the second end 214. The first and second sets of cutouts 209a, 209b form the two slots 221, 222 at the second end 214.

In the preferred embodiment, the attachments 250, 251 are fabricated from a plastic, such as a thermoset resin. In an alternative embodiment, however, the attachments are fabricated from metal, such as steel or an aluminum.

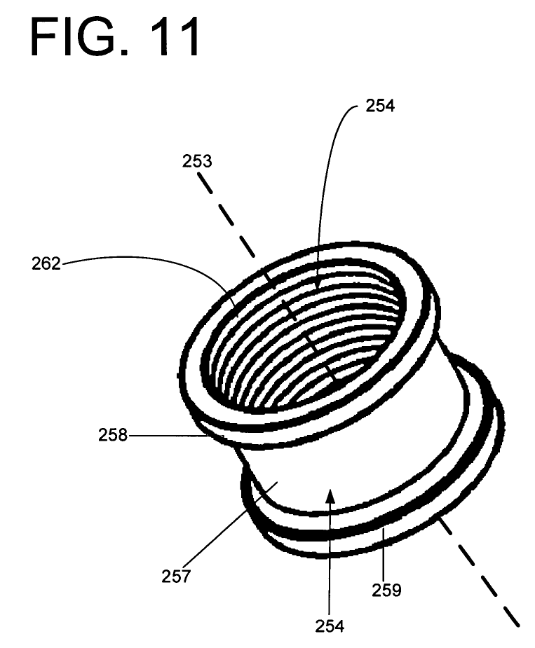

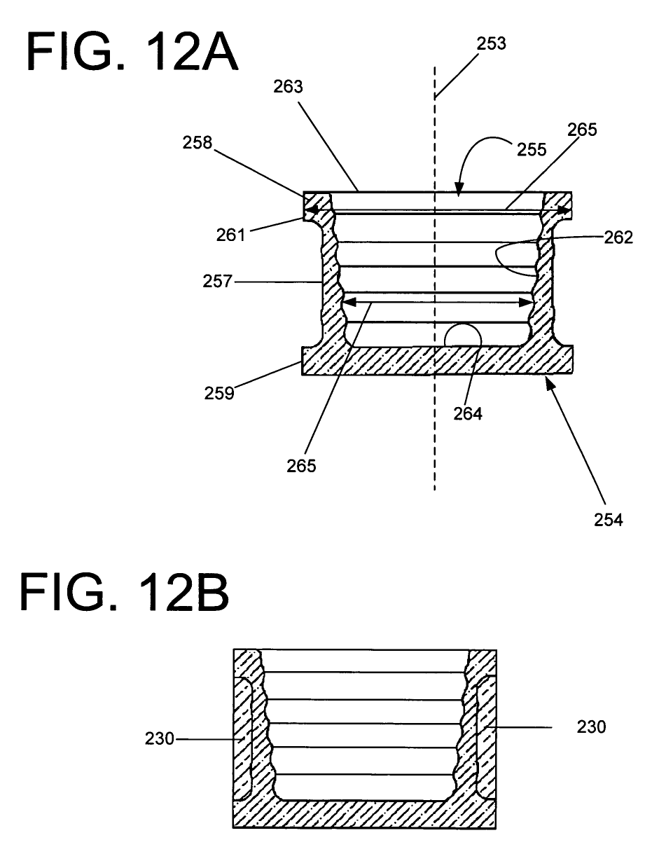

As shown in FIG. 7, the coupling member 200 includes a first end 213, where a first attachment 250 is secured, and a second end 214, where a second attachment 251 is secured. Advantageously, the slots 221, 222 on each end 213, 214 accept one of the attachments 250, 251 while the set of arms 219, 220 on each end 213, 214 secure one of the attachments 250, 251 to the coupling member 200 Turning now to FIGS. 11 and 12, the attachments 250, 251 are provided with an axis 253, an outer surface 254, and an inner surface 255. In the preferred embodiment, the inner surface 255 of the attachments 250, 251 receive a socket 520 and preferably secures the attachments 250, 251 to the socket through a press-fit. As shown in FIG. 11, the inner surface 255 is provided with a ridged surface 262 that extends between an opening 263 and a seating surface 264. The ridged surface 262 is shaped so that the diameter 265 of the inner surface 255 decreases from the opening 263 towards the seating surface 264. The ridged surface 262 is provided with a shape that is generally complementary to a ridged surface 526 that is provided on an outer surface 522 of the socket 520.

As shown in FIGS. 11 and 12, the outer surface is provided with a retaining surface 257. The retaining surface 257 extends radially about the axis 253 of the attachments 250, 251 and is preferably generally cylindrical in shape. The retaining surface 257 is preferably located adjacent to at least one flange 258 or 259. In the preferred embodiment, the retaining surface is located between a first flange 258 and a second flange 259 and recessed with respect to the flanges 258, 259. In the preferred embodiment, the retaining surface 257 provided with a frictional coefficient that is larger than the frictional coefficient of a generally smooth surface. In the preferred embodiment, the retaining surface 257 is generally coarse or roughened, however, in an alternative embodiment, the retaining surface 257 is generally smooth.

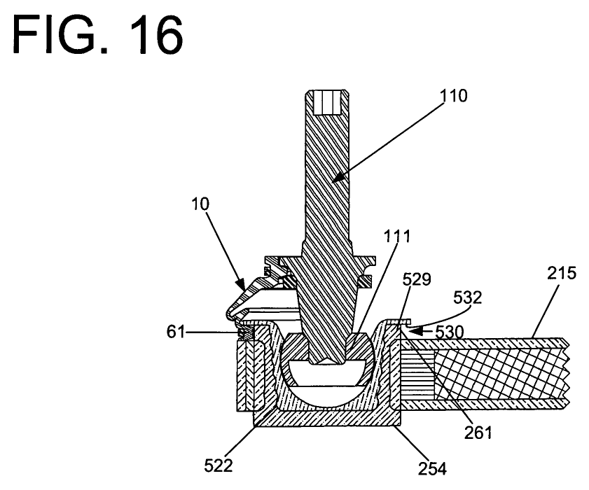

According to one aspect, the outer surface 254 is configured to cooperate with a seal 10. As shown in FIG. 16, the outer surface 254 cooperates with a socket outer surface 522 and the outer surface 215 of the coupling member 200 to define a seal acceptor 530 within which at least a portion of the seal 10 is located. In the preferred embodiment, the first flange 258 of the outer surface 254 is provided with a seal bearing surface 261. The seal bearing surface 261 preferably extends about the axis 253 and is preferably generally cylindrical in shape. As shown in FIG. 16, the seal bearing surface 261, the outer stem surface 215, and the socket outer surface 522 define a seal acceptor 530 within which a second securing member 61 of the seal 10 is fit within.

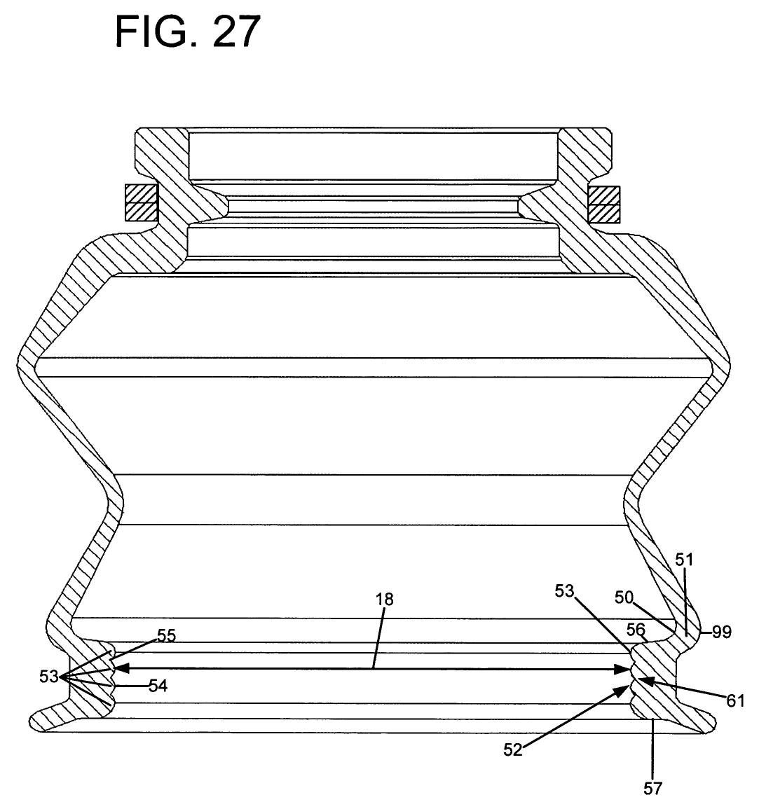

As shown in FIG. 12A, the seal bearing surface 261 is provided with a diameter 265. The diameter 265 is dimensioned according to a diameter 18 of the second securing member 61 (shown in FIG. 27) of the seal 10. Preferably, the diameter 265 of the seal bearing surface 261 is greater than the diameter 18 of the first sealing surface 52 on the second securing member 61.

In the preferred embodiment, the composite link 5 is fabricated by first providing one or more sheets of composite material that includes uni-directional fibers. The composite material is then cut to provide two sheets of composite material that each have a generally rectangular shape. One sheet of the composite material is utilized as the crossing element 202. The other sheet of the composite material is utilized as the composite element 201 and is further cut to provide the cutouts 209a, 209b and the extensions 210a, 210b on opposing sides 207, 208.

After the composite element 201 and crossing element 202 are sized and shaped, the coupling member 200 is fabricated by rolling the crossing element 202 around the core 206, as depicted in FIG. 9, and rolling the composite element 201 around the crossing element 202 as depicted in FIG. 7. Subsequently, the first and second plugs 280 are fabricated by rolling sheet 281 as shown in FIGS. 2A and 2B, and, then, as shown in FIG. 5B, the plugs 280 are inserted into the member cavity 217, whereby the axis 284 of the plugs 280 is substantially coaxial with the axis 211 of the coupling member 200.

Thereafter, a priming strip 230 of composite material is wrapped around each of the outer surfaces 254 on the attachments 250, 251. As shown in FIG. 12B, the first and second priming strips 230 are wrapped around the retaining surfaces 257 of the respective attachments 250, 251, whereby they are located between the flanges 258, 259. In the preferred embodiment, the priming strip 230 is fabricated from the same material as the composite element 201 or the crossing element 202 and is preferably provided with a plurality of layers through rolling or folding.

After the priming strips 230 are wrapped around the attachments, the arms 219, 220, as shown in FIG. 3-5A, are preferably flattened, whereby they are provided with a generally rectangular cross-sectional shape, as shown in FIG. 5B. Then, as shown in FIG. 6, the first attachment 250 is placed within the first and second slots 221, 222 on the first end 213 of the coupling member 200 and the second attachment 251 is placed within the first and second slots 221, 222 on the second end 214 of the coupling member 200.

Thereafter, the first and second arms 219, 220 on each of the first end 213 are then wrapped around the first priming strip and the first and second arms 219, 220 of the second end 214 are wrapped about the second priming strip 230. Preferably, the first and second arms 219 and 220 on the first end 213 are wrapped about the axis 253 of the attachment 250 and about at least a portion of the retaining surface 257 of the attachment 250, whereby the second arm 220 overlaps at least a portion of the first arm 219. Preferably, the first and second arms 219 and 220 on the second end 214 are wrapped about the axis 253 of the attachment 251 and about at least a portion of the retaining surface 257 of the attachment 251, preferably, whereby the first arm 219 overlaps at least a portion of the second arm 220.

The first and second arms 219, 220 on the first end 213 are then wrapped around the first priming composite element 230 and the first and second arms 219, 220 on the second end 214 are wrapped around the second priming composite element 230. Preferably, the first and second arms 219 and 220 on the first ends 213 200 are wrapped about the axis 140 of the attachments 250 and about at least a portion of the retaining surface 257 of the attachment 250 whereby the second arm 220 overlaps at least a portion of the first arm 219. The first and second arms 219 and 220 on the second end 214 are wrapped about the axis 140 of the attachments 250 and about at least a portion of the retaining surface 257 of the attachment 251 whereby the first arm 219 overlaps at least a portion of the second arm 220.

After wrapping the arms 219, 220, the coupling member 200, core 206, and attachments 250, 251 are placed into a cavity defined by a mold. The mold is preferably a two-piece metal mold and preferably includes a plurality of cavities for curing a plurality of coupling members 200 simultaneously. Upon insertion into the mold cavity, the coupling member 200 is cured by heating for about 1 hour at a temperature of about 300° F. and then cooled for about 15 minutes in water.

After the coupling member 200 is cured, the coupling member 200, core 206, and attachments 250, 251 are removed from the mold. As shown in FIG. 7B, the composite element, crossing element, the priming composite element, and the plug cure during the molding process to provide the coupling member 200

Then, in the preferred embodiment, a ball portion 111 of first and second ball studs 110 is press fit within the ball cooperating surfaces 525 of first and second sockets 520. Afterwards, the first and second sockets 520 are press fit within the inner surfaces 255 of the first and second attachments 250, 251. Subsequently, the first and second ball studs 110 and the first and second sockets 520 are lubricated with grease and a seal 10 is pressed over the ball joint 109. Thereafter, the first and second constricting elements 72 and 91 are installed on the seal 10 so that they are respectively located within the first and second retaining surfaces 68, 101.

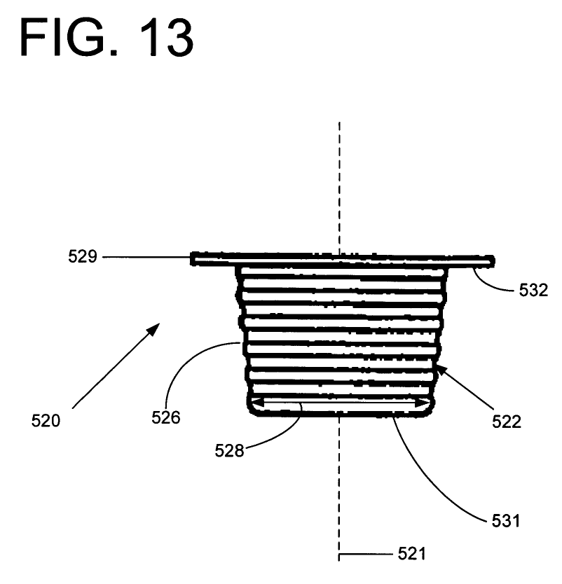

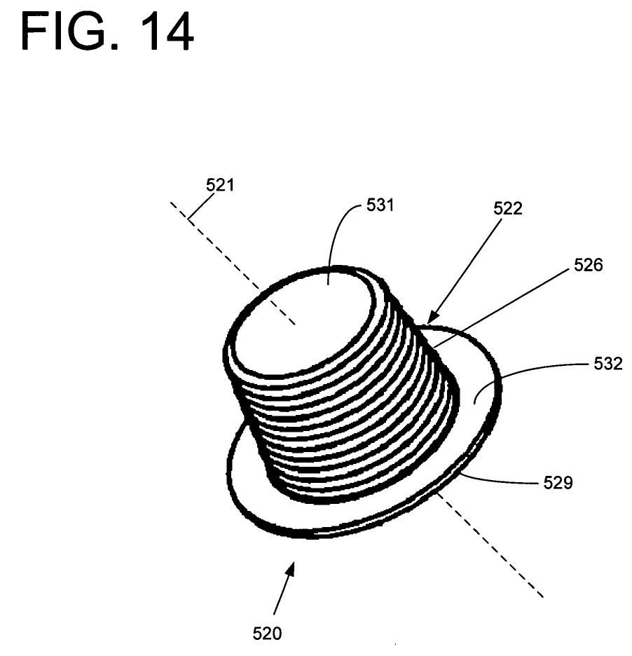

As shown in FIG. 1, the ball joint linkage 5 of the preferred embodiment is provided with at least one ball joint 109, and preferably two ball joints 109. As show therein, each ball joint 109 is provided with a socket 522 and a ball stud 110. Turning now to FIGS. 13, 14, and 15, the socket 520 is provided with a socket axis 521, an outer socket surface 522, and an inner socket surface 523. In the preferred embodiment, the socket 520 is fabricated from a polymer, such as an acetal.

In the preferred embodiment, the outer socket surface 522 is configured to be inserted within the inner surface 255 of the attachments 250, 251. As shown in FIGS. 13, 14, and 15, the outer socket surface 522 is provided with a ridged surface 526 that extends between a flange 529 and an end surface 531. As shown, the ridged surface 526 extends radially about the socket axis 521. The ridged surface 526 is shaped so that the diameter 528 of the outer socket surface 522 decreases from the flange 529 towards the end surface 531. The ridged surface 526 is provided with a shape that is generally complementary to a ridged surface 262 that is provided on an inner surface 255 of the attachments 250, 251.

According to one aspect, the outer socket surface 522 is configured to cooperate with a seal 10. According to another aspect, the outer socket surface 522 cooperates with the outer surface 254 of the attachments 250, 251 and the outer surface 215 of the coupler to define a seal acceptor 530 within which at least a portion of the seal 10 is located. In the preferred embodiment, depicted in FIGS. 13, 14, and 15 the outer socket surface 522 includes a flange 529 that is provided with an accommodating surface 532, which is preferably located on the underside of the flange 529. As shown, the accommodating surface 532 extends about the axis 521 and preferably generally annular in shape. As shown in FIG. 16, the sealing accepting surface 532 on the outer socket surface 522, cooperates with the outer surface 215 of the coupling member 200 and the outer surface 254 of the attachments 250, 251 define a seal acceptor 530 within which a second securing member 61 of the seal 10 is fit within.

As shown in FIG. 12A, the seal bearing surface 261 is provided with a diameter 265. The diameter 265 is dimensioned according to a diameter 18 of the first sealing surface 52 on the securing member 61 (shown in FIG. 27) of the seal 10. Preferably, the diameter 265 of the seal bearing surface 261 is greater than the diameter 18 of the second securing member 61 so that second securing member elastically fits around the seal bearing surface 261.

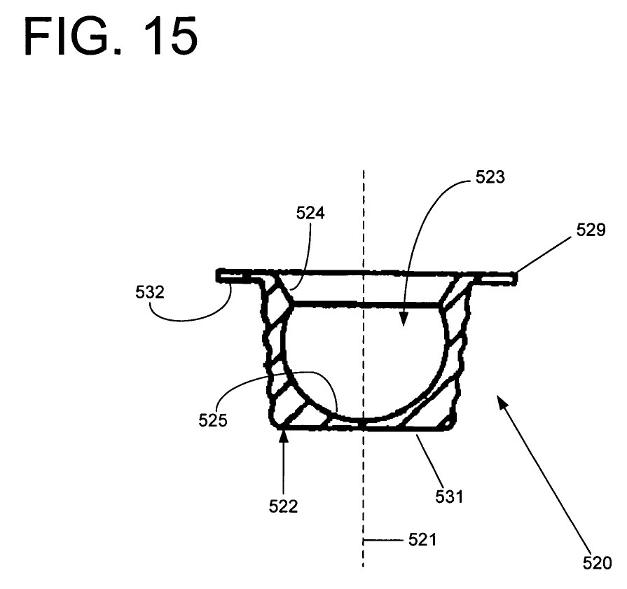

The inner socket surface 523 is configured to cooperate with a ball stud 110. As shown in FIG. 15, the inner socket surface 523 is preferably provided with a chamfer 524 and a ball cooperating surface 525. Turning now to FIG. 16, the ball cooperating surface 525 is dimensioned so that the at least a portion of the ball stud 110 fits within the ball cooperating surface 525. In the preferred embodiment, the ball portion 111 is press-fit within the inner socket surface 523 of the socket 520. According to another aspect of the present invention, the ball cooperating surface 525 is shaped so that the ball stud 110 is able to pivot therein.

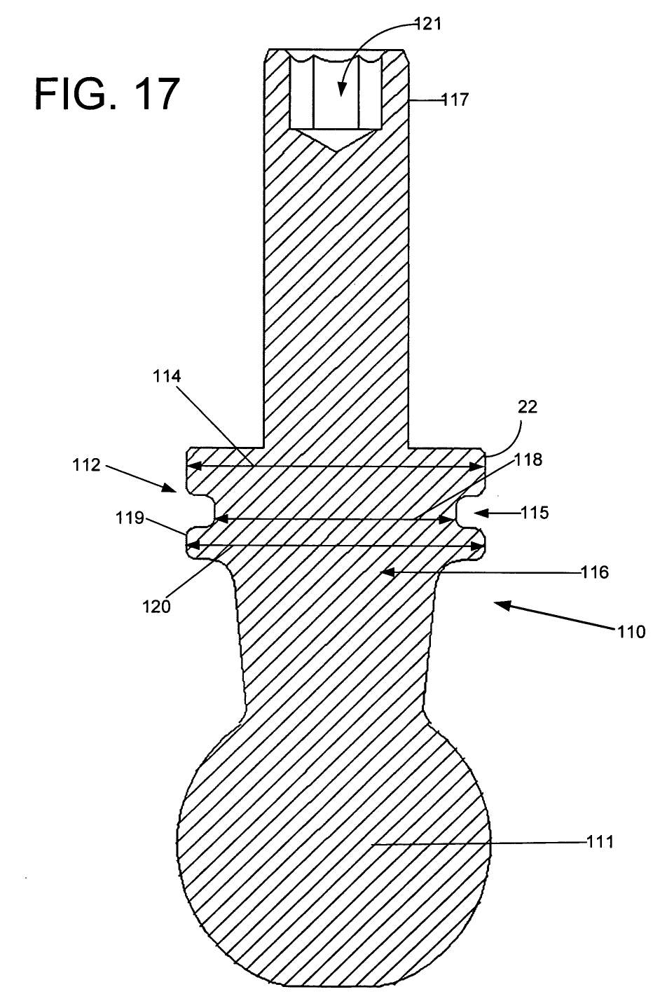

As shown in FIG. 1, the composite link 5 is provided with a ball stud 110. FIG. 17 depicts a ball stud 110 of an embodiment of the present invention. As shown therein, the ball stud 110 is provided with a ball portion 111 that is configured to cooperate with the socket 520. According to one aspect of the present invention, the ball portion 111 is configured to fit within a portion of the socket 520. According to another aspect of the present invention, the ball portion 111 is configured to pivot within a portion of the socket 520. As shown, the ball portion 111 is provided with at least a partially spherical shape. In the preferred embodiment, the ball portion 111 is press fit within the ball cooperating surface 521 of the socket 520 and is able to pivot therein.

As shown in FIG. 17, the ball stud 110 is provided with a shaft 116 having a cylindrical shaft portion 117. Advantageously, the cylindrical shaft portion 117 is connectable to a suspension arm/torsion bar.

The shaft 116 is preferably provided with a torque transmitter 121. The torque transmitter 121 is configured to transmit torque. The preferred embodiment is show in FIG. 17 with a torque transmitter 121 that is in the shape of a polygon, preferably a hexagon; however, other configurations that transmit torque are within scope of this invention. As depicted in FIG. 17, the torque transmitter 121 is located within the shaft 116 in the form of an internal drive, preferably as a six point internal drive. However, other internal drives may be used without departing from the scope of the present invention.

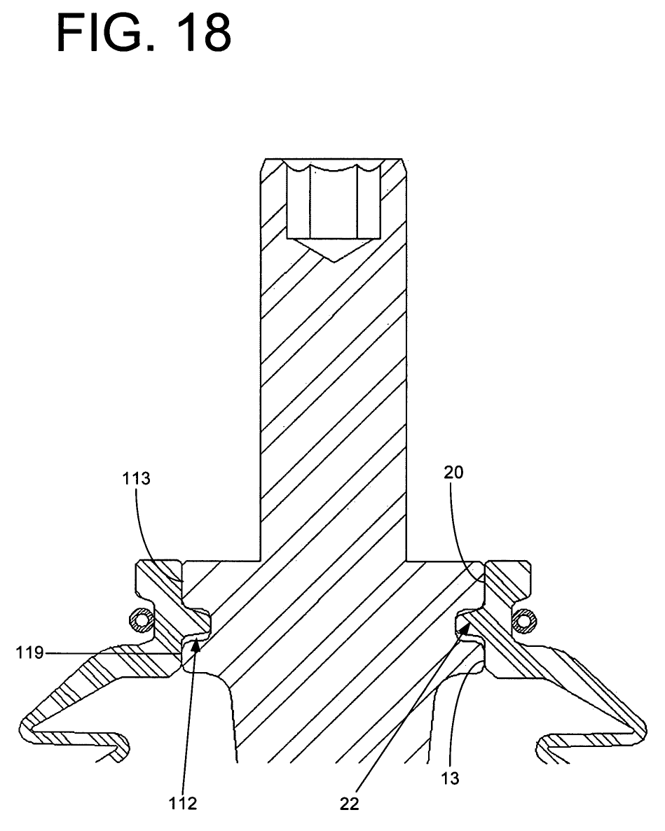

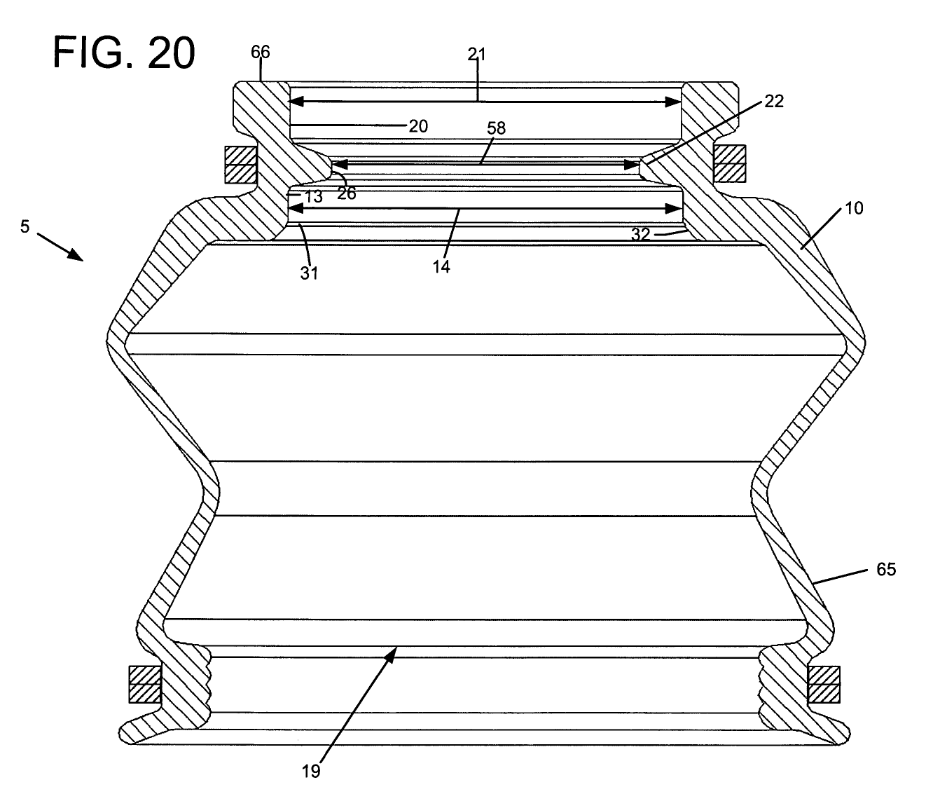

The shaft 116 is provided with a seal cooperating surface 112 configured to cooperate with the seal 10. As shown in FIG. 18, the seal cooperating surface 112 is shaped according to at least a portion of the first securing member 22. FIG. 17 depicts the seal cooperating surface 112 of the preferred embodiment provided with a first cylindrical surface 113 having a diameter 114. The diameter 114 is related to a diameter 21 (shown in FIG. 20) of the first interface surface 20. Preferably, the diameter 114 is larger than the diameter 21 of the first interface surface 20.

As shown in FIG. 17, located within the seal cooperating surface 112 is a seal acceptor 115. The seal acceptor 115 is configured to cooperate with the seal 10. According to one aspect of the present invention, the seal acceptor 115 is dimensioned so that a portion of the seal 10 is fit within the seal acceptor 115.

As shown in FIG. 18, the first securing member 22 of the seal 10 preferably fits within the seal acceptor 115. As depicted therein, the seal acceptor 115 is shaped to accommodate the first securing member 22. Advantageously, the first securing member 22 fits within the seal acceptor 115 so that a lubricant is retained with the seal 10. As shown in FIG. 17, the seal acceptor 115 is a surface having a diameter 118 that is smaller than the diameter 114 of the seal cooperating surface 112.

As shown in FIG. 17, the seal cooperating surface 112 of the preferred embodiment is provided with a second cylindrical surface 119 having a diameter 120. The diameter 120 is related to a diameter 14 of the second interface surface 13. Preferably, the diameter 120 is larger than the diameter 14 of the second interface surface 13.

As shown in FIG. 1, the composite link 5 is provided with a seal 10. The seal 10 is made from a material, such as, for example, a vulcanized material, that provides resilience and is able to withstand temperatures exceeding 100° F. In the preferred embodiment, the seal 10 is fabricated from neoprene rubber. In alternative embodiment, the seal 10 is fabricated from an elastomer, such as polyurethane.

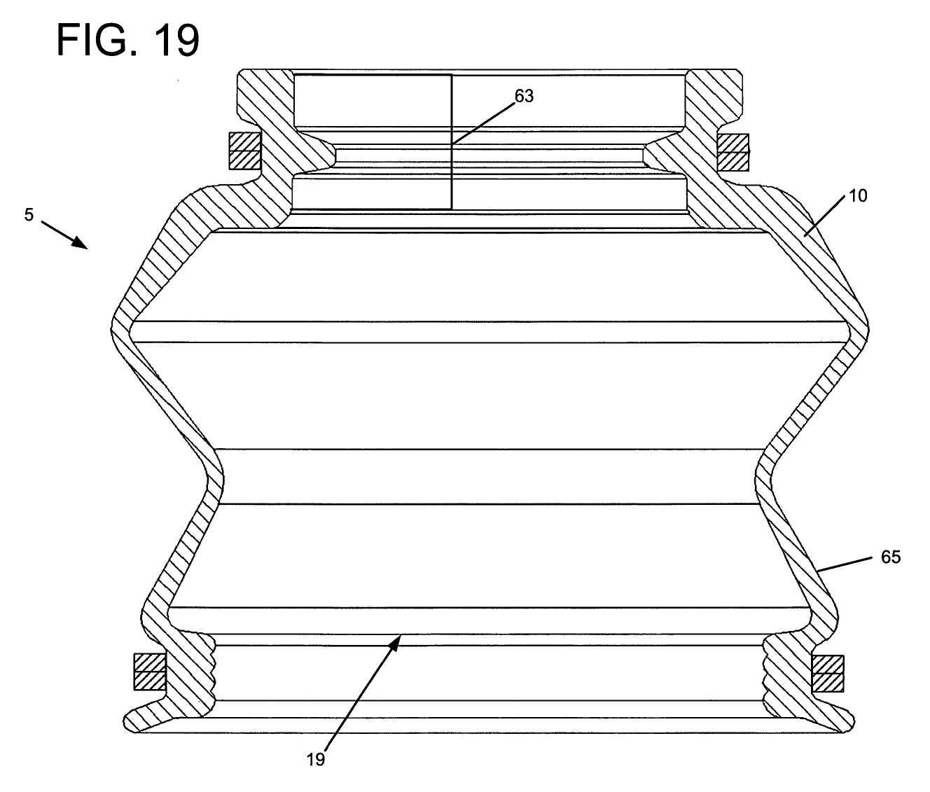

As shown in FIG. 19, the seal is provided with an inner surface 19 that is configured to cooperate with a joint. In the preferred embodiment the inner surface 19 is configured to cooperate with a ball joint, such as, for example, ball joint 109 depicted in FIG. 1. According to another aspect of the present invention, the inner surface 19 is configured to cooperate with a shaft on a ball stud, such as, for example, the shaft 116 on ball stud 110 depicted in FIG. 17.

Referring again to FIG. 19, the inner surface 19 of the seal 10 is provided with a shaft cooperating surface 63. According to one aspect, the shaft cooperating surface 63 is configured to retain the seal 10 on a ball stud 110 so that the seal 10 is capable of torsional movement with respect to the ball stud 110. According to another aspect, the shaft cooperating surface 63 provides a seal for the lubricant within the inner surface 19. According to yet another aspect, the shaft cooperating surface 63 is configured to prevent seal wind-up and fatigue. According to yet another aspect, the shaft cooperating surface 63 is shape according to a shaft so that the seal 10 flexes at a predetermined flex area.

As shown in FIG. 20, the shaft cooperating surface 63 is provided with a first interface surface 20, a first securing member 22, and a second interface surface 13. The first interface surface 20 is configured to cooperate with a shaft, preferably a shaft 116 on a ball stud 110. As shown in FIG. 18, the first interface surface 20 and is shaped correspondingly to the shaft 116, more specifically to a first cylindrical surface 113 located on the seal cooperating surface 112 of the shaft 116.

As best depicted in FIG. 20, the first interface surface 20 of the preferred embodiment is cylindrical in shape. While FIG. 20 depicts a cylindrically shaped first interface surface 20, in an alternative embodiment, the first interface surface 20 is conical or frusto-conical in shape.

As shown in FIG. 20, the first interface surface 20 is provided with a diameter 21, which in the preferred embodiment is dimensioned according to a diameter of the shaft 116. In the preferred embodiment, the diameter 21 is dimensioned according to the seal cooperating surface 112 located on the shaft 116. Preferably, the diameter 21 is smaller than a diameter 114 (shown in FIG. 17) of a first cylindrical surface 113 located on the seal cooperating surface 112. As shown in FIG. 18, the diameter 21 elastically expands to accommodate a diameter 114 (shown in FIG. 17) of the seal cooperating surface 112.

As shown in FIG. 20, adjacent to the first interface surface 20 is a first securing member 22. The first securing member 22 is configured to cooperate with a shaft 116. FIG. 18 depicts the first securing member 22 fit within a seal acceptor 115 located on the shaft 116.

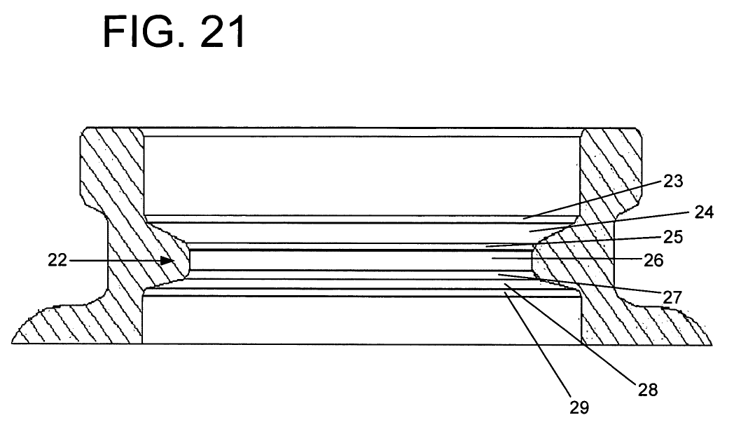

Referring now to FIG. 21, the first securing member 22 is provided with a first transitional surface 23. The first transitional surface 23 is shaped to provide the first securing member 22 with a tighter fit within the seal acceptor 115. As shown, the first transitional surface 23 is generally concave in shape.

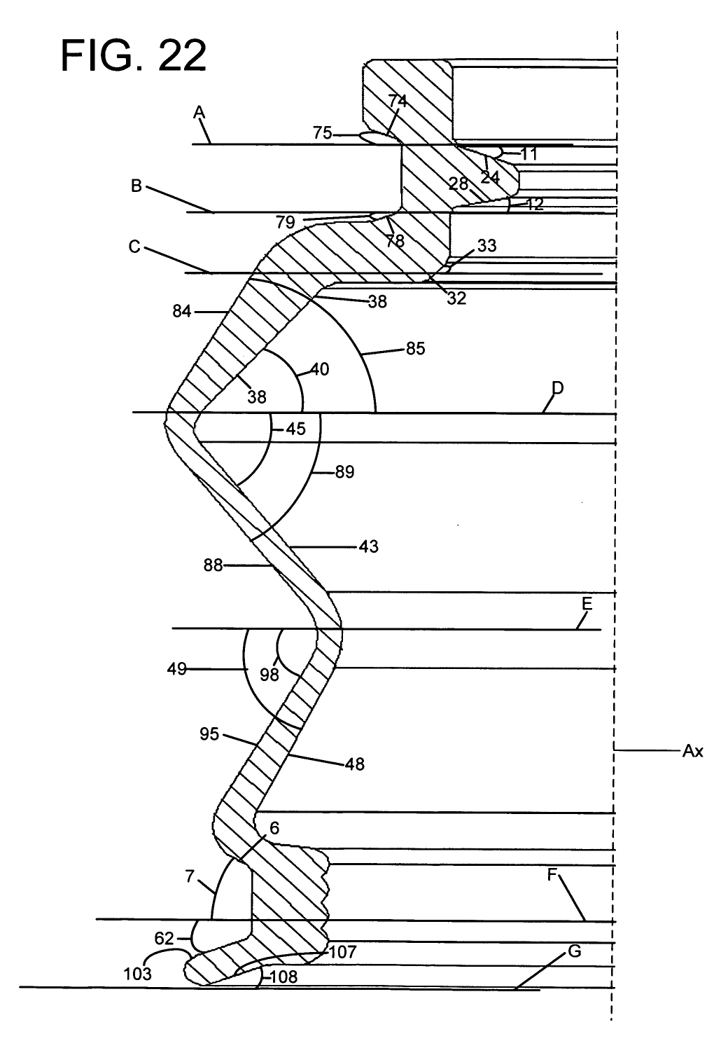

Adjacent to the first transitional surface 23 is a first inner frusto-conical surface 24. The first inner frusto-conical surface 24 is at an angle. As shown in FIG. 22, the first inner frusto-conical surface 24 is at an angle 11, with respect to imaginary line A, which runs perpendicular to an axis Ax of the seal 10. In the preferred embodiment, the angle 11 is 6°.

As shown in FIG. 21, the first inner frusto-conical surface 24 is located adjacent to a second transitional surface 25. The second transitional surface 25 is shaped to provide the first securing member 22 with a tighter fit within the seal acceptor 115. As shown in FIG. 21, the second transitional surface 24 is generally convex in shape.

Adjacent to the second transitional surface 25 is an inner cylindrical surface 26. As shown in FIG. 20, the inner cylindrical surface 26 is provided with a diameter 58. In the preferred embodiment, the diameter 58 of the inner cylindrical surface 26 is dimensioned to retain the seal 10 on the ball stud 110 and to provide a seal for the lubricant within the inner surface 19 of the seal 10. In the preferred embodiment, the diameter 58 of the inner cylindrical surface 26 is dimensioned according to a diameter 118 (shown in FIG. 17) of the seal acceptor 115 on the shaft 116, preferably smaller so that the first securing member 22 elastically fits around the shaft 116.

As shown in FIG. 21, adjacent to the inner cylindrical surface 26 is a third transitional surface 27. In the preferred embodiment, the third transitional surface 27 is shaped to provide the first securing member 22 with a tighter fit within the seal acceptor 115 on the shaft 116. As shown in FIG. 21, the third transitional surface 27 is generally convex in shape and is located adjacent to a second inner frusto-conical surface 28.

Referring now to FIG. 22, the second inner frusto-conical surface 28 is at an angle 12 with respect to imaginary line B, which runs perpendicular to the axis Ax of the seal 10. In the preferred embodiment, the angle 12 is 14°.

As shown in FIG. 21, located adjacent to the second inner frusto-conical surface 28 is a fourth transitional surface 29. The fourth transitional surface 29 is shaped to provide the first securing member 22 with a tighter fit within the seal acceptor 115. As shown in FIG. 21, the fourth transitional surface 29 is generally convex in shape.

While the first securing member 22 is depicted herein as including a plurality of surfaces, in an alternative embodiment, the first securing member 22 is made without the first transitional surface 23, the second transitional surface 25, the third transitional surface 27, or the fourth transitional surface 29.

Turning now to FIG. 20, located adjacent to the first securing member 22 is a second interface surface 13, which in the preferred embodiment is also configured to cooperate with the shaft 116. FIG. 18 depicts the second interface surface 13 shaped according to the second cylindrical surface 119 located on the seal cooperating surface 112 of the shaft 116. As shown therein, the second interface surface 13 is cylindrical in shape. However, in an alternative embodiment, the second interface surface 13 is conical or frusto-conical in shape.

As shown in FIG. 20, the second interface surface 13 is provided with a diameter 14. The diameter 14 is dimensioned according to the shaft 116. In the preferred embodiment, the diameter 14 is dimensioned according to the seal cooperating surface 112 located on the shaft 116. Preferably, the diameter 14 is smaller than a diameter 120 (shown in FIG. 17) of the second cylindrical surface on the seal cooperating surface 112 so that the diameter 14 elastically expands to accommodate the diameter 120 of the seal cooperating surface 112.

As depicted in FIG. 20, located adjacent to the second interface surface 13 a fifth transitional surface 31. As shown in FIG. 20, the fifth transitional surface 31 is generally convex in shape. Although the presently preferred embodiment of the seal 10 is provided with a fifth transitional surface 31, the seal 10 of an alternative embodiment is fabricated without the fifth transitional surface 30.

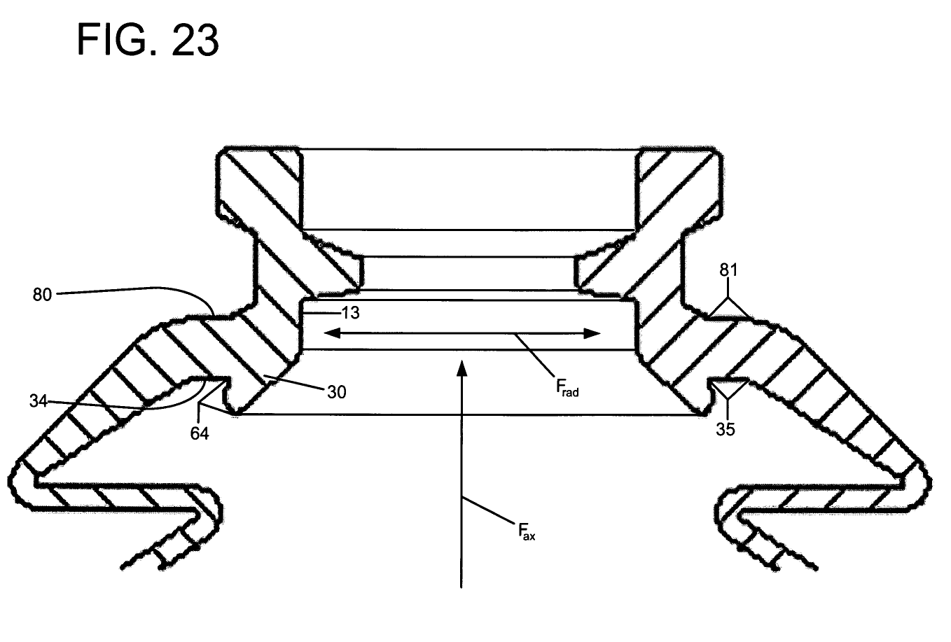

The presently preferred embodiment is provided with a first installation member 30, which is shown in FIG. 23. According to one aspect of the present invention, the first installation member 30 is shaped to cooperate with a shaft. In the preferred embodiment, the first installation member 30 is configured to cooperate with the shaft 116 located on a ball joint 109. According to another aspect of the present invention, the first installation member 30 is shaped to cooperate with the outer surface 65 of the seal 10. According to yet another aspect of the present invention, the first installation member 30 is shaped to cooperate with the first annular surface 66 (shown in FIG. 20).

As shown in FIG. 23, the first installation member 30 is provided with an overhang 64. During installation, the first installation member 30 translates an axial force Fₐₓ into a radial force F_{rad} so that at least one of the diameters 14, 21, and 58 (shown in FIG. 20) of the shaft cooperating surface 69 is increased.

While the presently preferred embodiment is shown with a first installation member 30 that provides greater ease in installing the seal 10, in an alternative embodiment, the seal 10 is fabricated without the first installation member 30. By way of example, in the embodiment depicted in FIG. 20, adjacent to the fifth transitional surface 31 is a sliding surface 32. As shown in FIG. 22, the sliding surface 32 is at an angle 33 with respect to an imaginary line C, which runs perpendicular to an axis Ax of the seal 10. In the preferred embodiment, angle 33 is 30°.

As shown in FIG. 23, the seal 10 is preferably provided with an inner corresponding surface 34 configured to cooperate with the outer surface 65. As depicted therein, the inner corresponding surface 34 is in a plane generally parallel to the outer corresponding surface 80 so that, after fabrication, the seal 10 shrinks uniformly during cooling. In the preferred embodiment, the inner corresponding surface 34 is generally annular, extending a radial distance 35 that corresponds to the radial distance 81 of the outer corresponding surface 80.

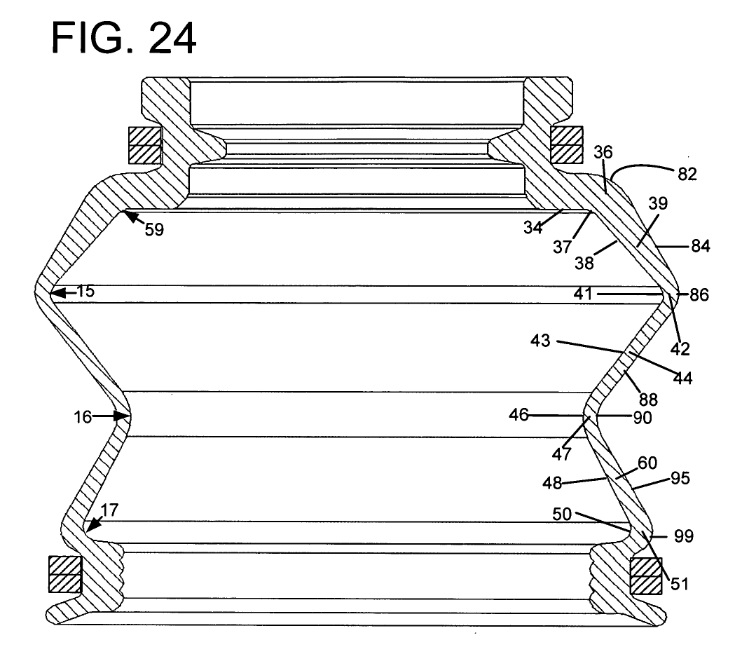

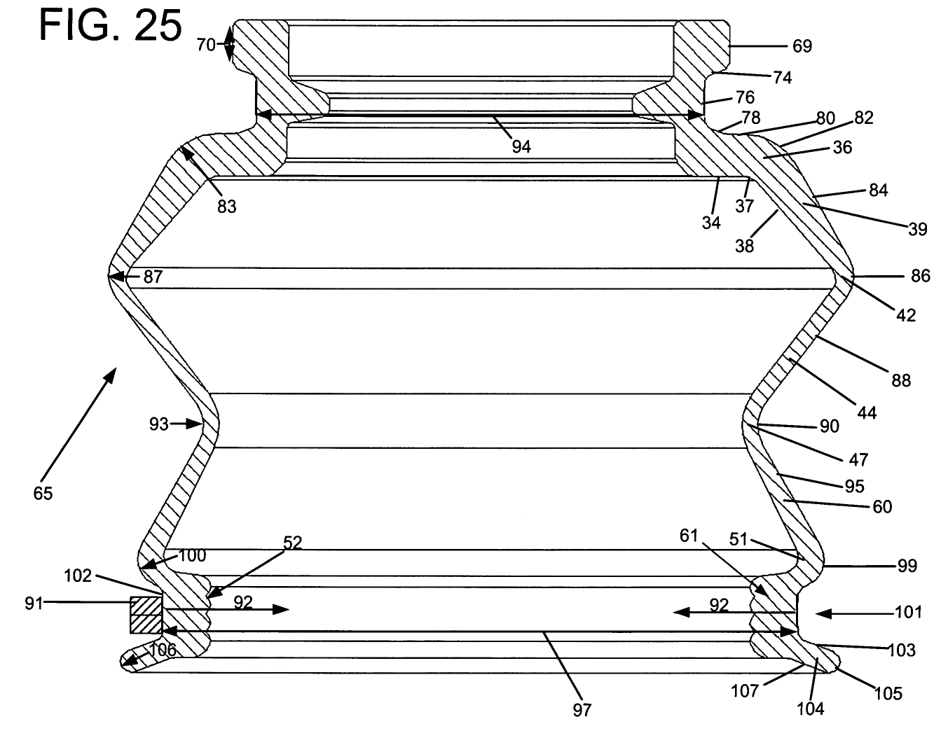

Referring now to FIG. 24, the seal 10 is provided with a first flex area 36. The first flex area 36 is shaped so that the seal 10 bends at flex area 36. In the preferred embodiment, the first flex area 36 includes cooperating curved surfaces, which, in FIG. 24, are depicted as a first inner curved surface 37 and a first outer curved surface 82. The first outer curved surface 82 and the first inner curved surface 37 are shaped cross-sectionally as arcs of imaginary circles. As shown in FIG. 25, the imaginary circle corresponding to the first outer curved surface 82 has a radius 83 preferably measuring 2.5 cm. As shown in FIG. 24, the imaginary circle corresponding to the first inner curved surface 37 has a radius 59 preferably measuring 0.5 cm.

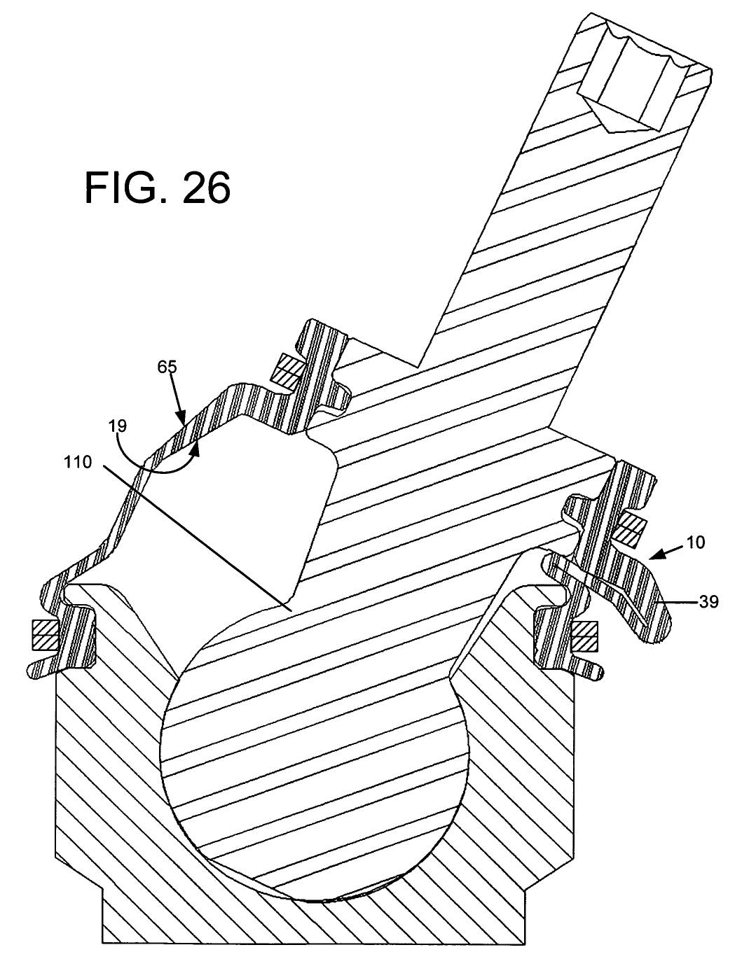

The seal 10 is provided with a plurality of seal portions 39, 44, and 60 having predetermined lengths, dimensioned according to the range of motion of the ball stud 110. Referring to FIG. 24, adjacent to the first flex area 36 is a first seal portion 39 that is formed with first inner and first outer angled surfaces, designated as 38 and 84 in FIG. 24, respectively. The first inner angled surface 38 and the first outer angled surface 84 are configured to cooperate with each other. As shown in FIG. 24, the first inner angled surface 38 and the first outer angled surface 84 are shaped so that the first seal portion 39 is tapered. As shown in FIG. 26, the first seal portion 39 is tapered so that, when a portion of the seal 10 compresses axially, the seal 10 extends radially from the ball stud 110.

Referring now to FIG. 22, the first inner angled surface 38 and the first outer angled surface 84 are depicted in greater detail. As shown therein, the first inner angled surface 38 and the first outer angled surface 84 are at an angle with respect to imaginary line D, which runs perpendicular to the axis Ax of the seal 10. The angle corresponding to the first inner angled surface 38, designated angle 40 in FIG. 22, measures 51°, while the angle corresponding to the first outer angled surface 84, designated angle 85 in FIG. 22, measures 60°.

Referring again to FIG. 24, a second flex area 42 is shown adjacent to the first seal portion 39. The second flex area 42 is shaped so that the seal 10 bends at flex area 42. In the preferred embodiment, the second flex area 42 includes cooperating curved surfaces, shown in FIG. 24 as a second inner curved surface 41 and a second outer curved surface 86. The second outer curved surface 86 and the second inner curved surface 86 are shaped cross-sectionally as arcs of imaginary circles. As shown in FIG. 25, the imaginary circle corresponding to the second outer curved surface 86 has a radius 87 preferably measuring 1.5 cm. As shown in FIG. 24, the imaginary circle corresponding to the second inner curved surface 41 has a radius 15 preferably measuring 0.5 cm.

Adjacent to the second flex area 42 is a second seal portion 44 that is formed with second inner and outer surfaces, designated 43 and 88 in FIG. 24, respectively. The second inner angled surface 43 and the second outer angled surface 88 are configured to cooperate with each other. The second inner angled surface 43 and the second outer angled surface 88 are shaped so that the second seal portion 44 is provided with a uniform thickness. As shown in FIG. 22, the second inner angled surface 43 and the second outer angled surface 88 are at an angle with respect to imaginary line D, which runs perpendicular to the axis Ax of the seal 10. The angle corresponding to the second inner angled surface 43, designated angle 45 in FIG. 22, and the angle corresponding to the second outer angled surface 88, designated 89 in FIG. 22, both measure 50°.

Adjacent to the second seal portion 44 is a third flex area 47. The third flex area 47 is shaped so that the seal 10 bends at flex area 47. In the preferred embodiment, the third flex area 47 includes cooperating curved surfaces, shown in FIG. 24 as a third inner curved surface 46 and a third outer curved surface 90. The third outer curved surface 90 and the third inner curved surface 46 are shaped cross-sectionally as arcs of imaginary circles. As shown in FIG. 25, the imaginary circle corresponding to the third outer curved surface 90 has a radius 93 preferably measuring 1.5 cm. As shown in FIG. 24, the imaginary circle corresponding to the third inner curved surface 46 has a radius 16 preferably measuring 2.50 cm.

Adjacent to the third flex area 47 is a third seal portion 60 that is formed with third inner and third outer angled surfaces, designated as 48 and 95 in FIG. 24, respectively. The third inner angled surface 48 and the third outer angled surface 95 are configured to cooperate with each other. The third inner angled surface 48 and the third outer angled surface 95 are shaped so that the third seal portion 60 is tapered.

Referring now to FIG. 22, the third inner angled surface 48 and the third outer angled surface 95 are depicted. As shown therein, the third inner angled surface 48 and the third outer angled surface 95 are at angles 49 and 98 with respect to imaginary line E, which runs perpendicular to the axis Ax of the seal 10. The angle corresponding to the third inner angled surface 48, designated angle 49 in FIG. 22, measures 62°, while the angle corresponding to the third outer angled surface 95, designated angle 98 in FIG. 22, measures 61°.

In FIG. 24, a fourth flex area 51 is shown adjacent to the third seal portion 60. The fourth flex area 51 is shaped so that the seal 10 bends at flex area 51. In the preferred embodiment, the fourth flex area 51 includes cooperating curved surfaces shown in FIG. 24 as a fourth inner curved surface 50 and a fourth outer curved surface 99. The fourth outer curved surface 99 and the fourth inner curved surface 50 are shaped cross-sectionally as arcs of imaginary circles. As shown in FIG. 25, the imaginary circle corresponding to the fourth outer curved surface 99 has a radius 100 preferably measuring 1.25 cm. As shown in FIG. 24, the imaginary circle corresponding to the fourth inner curved surface 50 has a radius 17 preferably measuring 0.75 cm.

Turning now to FIG. 27, adjacent to the fourth flex area 51 is a second securing member 61. In the preferred embodiment, as shown in FIG. 16, the second securing member 61 is configured to fit within a seal acceptor 530 defined by the socket 520, the coupling member 200, and an attachment 250 or 251.

Referring now to FIG. 27, the second securing member 61 is provided with a plurality of sealing surfaces. In the preferred embodiment, the second securing member 61 is provided with a first sealing surface 52. In the preferred embodiment, the first sealing surface 52 is configured to cooperate with an attachment 250 or 251. As shown in FIG. 16, the first sealing surface 52 is shaped to fit within the seal acceptor 530 and exert a force on the seal bearing surface 261 of the attachments 250, 251.

In the preferred embodiment, the first sealing surface 52 is shaped to grip the seal bearing surface that defines at least in part the seal acceptor 530. Advantageously, the first sealing surface 52 is provided with a surface shaped to have an increased frictional coefficient relative to a smooth surface. As shown in FIG. 27, in the preferred embodiment, the first sealing surface 52 is provided with one or more undulations 53. As shown therein, the first sealing surface 52 is provided with four (4) undulations 53. The undulations 53 are generally convex in shape and are provided with an apex 54. As depicted in FIG. 27, the undulations 53 are spaced from each other by a valley 55.

As best depicted in FIG. 27, the first sealing surface 52 is provided with a diameter 18. In the preferred embodiment, the diameter 18 is dimensioned according to the diameter 265 (shown in FIG. 12A) of the seal bearing surface 261 on an attachment 250 or 251. Preferably, the diameter 18 of the first sealing surface 52 is smaller than the diameter 265. In the preferred embodiment, the diameter 18 elastically expands to accommodate the diameter 265 of the seal bearing surface 261.

As shown in FIG. 27, adjacent to the first sealing surface 52 is a second sealing surface 56 and a third sealing surface 57. In the preferred embodiment, the second sealing surface 56 and the third sealing surface 57 are shaped to fit within a notch, or preferably, a seal acceptor 530 (shown in FIG. 16). Advantageously, the second and third sealing surfaces 56, 57 cooperate with the seal acceptor 530 to provide a lubricant-tight seal.

As depicted in FIG. 19, the seal 10 is provided with an outer surface 65. The outer surface 65 is configured to cooperate with the inner surface 19. By way of example and not limitation, FIG. 26 depicts the outer surface 65 configured so that the seal 10 flexes at predetermined flex areas.

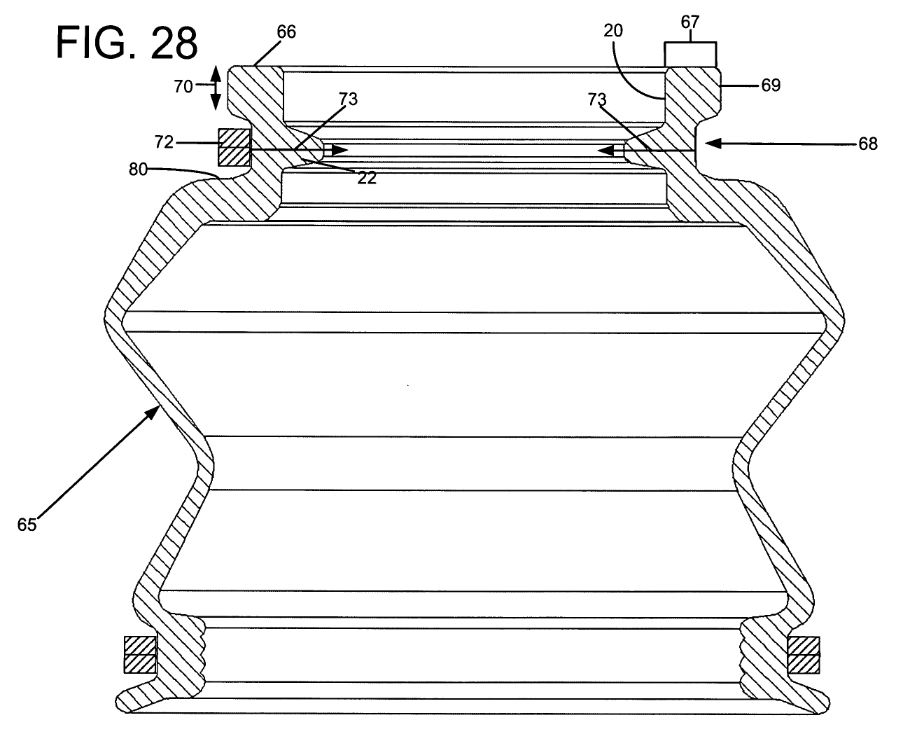

Referring now to FIG. 28, the outer surface 65 is provided with a first annular surface 66 located adjacent to the first interface surface 20. The first annular surface 66 has a width 67. The width 67 is dimensioned to cooperate with a shaft. More particularly, the width 67 is dimensioned to provide a predetermined amount of elasticity.

Located adjacent to the first annular surface 66 is a first outer cylindrical surface 69. As shown in FIG. 28, the first outer cylindrical surface 69 has a length 70 that provides the seal 10 with sufficient rigidity so that a first constricting element 72 is retained on the seal 10.

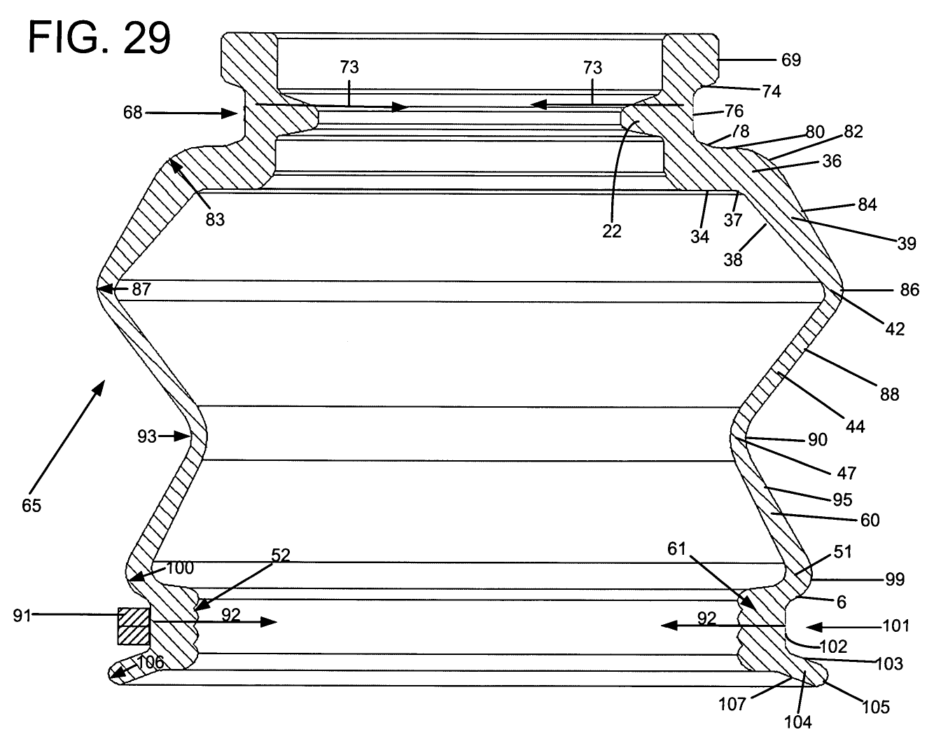

Referring again to FIG. 28, located adjacent to the first outer cylindrical surface 69 is a first retaining surface 68. The first retaining surface 68 is configured to cooperate with the first constricting element 72. According to one aspect of the present invention, the first retaining surface 68 is shaped to retain the first constricting element 72. According to another aspect of the present invention, the first retaining surface 68 is shaped so that the first constricting element 72 exerts a force in the direction of arrow 73 (shown in FIG. 29). According to yet another aspect of the present invention, the first retaining surface 68 is shaped so that the first constricting element 72 exerts a force on the first securing member 22.

The first retaining surface 68 is provided with a plurality of surfaces. Referring now to FIG. 29, the first retaining surface 68 of the preferred embodiment is provided with a first outer frusto-conical surface 74 shaped so that the first constricting element 72 exerts a force in the direction of arrow 73 (shown in FIG. 29), preferably a predetermined force on the first securing member 22. The first outer frusto-conical surface 74 is angled. As shown in FIG. 22, the first outer frusto-conical surface 74 is at an angle 75 with respect to imaginary line A, which runs perpendicular to the axis Ax of the seal 10. In the preferred embodiment, the angle 75 is 20°.

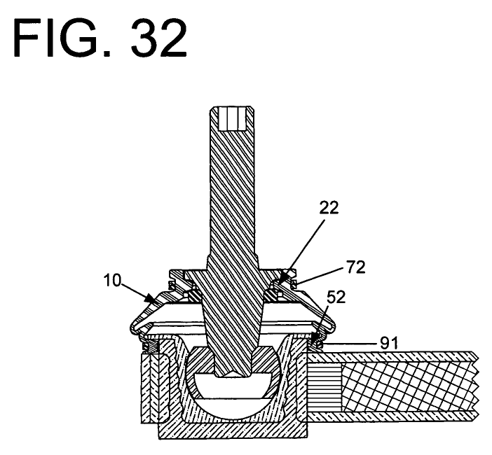

The first outer frusto-conical surface 74 is adjacent to a second outer cylindrical surface 76. The second outer cylindrical surface 76, located within the first retaining surface 68, is provided with a diameter 94. As shown in FIG. 32, the diameter 94 is dimensioned according to the diameter 8 of the first constricting element 72. Preferably, the second outer cylindrical surface 76 is provided with a diameter such that the first constricting element 72 exerts a force on the first securing member 22. The force is related to the spring constant of the first constricting element 72.

As shown in FIG. 29, adjacent to the second outer cylindrical surface 76 is a second outer frusto-conical surface 78 shaped so that the first constricting element exerts a force in the direction of arrow 73 (shown in FIG. 29), preferably a predetermined force on the first securing member 22. As shown in FIG. 22, the second outer frusto-conical surface 78 is at an angle 79 with respect to imaginary line B, which runs perpendicular to the axis Ax of the seal 10. In the preferred embodiment, the angle 79 is 20°.

As shown in FIG. 23, the presently preferred embodiment is provided with an outer corresponding surface 80 shaped so that the first constricting element 72 is positioned with greater accuracy, such as when the first constricting element 72 is positioned via an automated process. As depicted in FIG. 23, the outer corresponding surface 80 is in a plane generally parallel to the inner corresponding surface 34, so that, after fabrication, the seal 10 shrinks uniformly during cooling. In the preferred embodiment, the outer corresponding surface 80 is generally annular, extending a radial distance 81 that corresponds to the radial distance 35 of the inner corresponding surface 34.

Referring now to FIG. 29, the seal 10 is provided with a second retaining surface 101. The second retaining surface 101 is configured to cooperate with a second constricting element 91. According to one aspect of the present invention, the second retaining surface 101 is shaped to retain the second constricting element 91. According to another aspect of the present invention, the second retaining surface 101 is shaped so that the second constricting element 91 exerts a force in the direction of arrow 92. According to yet another aspect of the present invention, the second retaining surface 91 is shaped so that the second constricting element 91 exerts a force on the second securing member 61.

The second retaining surface 101 is provided with a plurality of surfaces. Referring again to FIG. 29, the second retaining surface 101 is provided with the third outer frusto-conical surface 6. As shown in FIG. 22, the third outer frusto-conical surface 6 is at an angle 7 with respect to imaginary line F, which runs perpendicular to the axis Ax of the seal 10. In the preferred embodiment, the angle 7 is 23°.

The third outer frusto-conical surface 6 is shaped to retain the second constricting element 91 within the second retaining surface 101. The third outer frusto-conical surface 6 is also shaped so that the second constricting element 91 exerts a force in the direction of arrow 92 (shown in FIG. 29), preferably a predetermined force on the second securing member 61. Furthermore, the third outer frusto-conical surface 6 is shaped so that the second constricting element 91 is positioned with greater accuracy, such as when the second constricting element 91 is positioned via an automated process.

The third outer frusto-conical surface 6 is adjacent to a third outer cylindrical surface 102. The third outer cylindrical surface 102 is provided with a diameter 97. As shown in FIG. 32, the diameter 97 is dimensioned according to the diameter 9 of the second constricting element 91. The third outer cylindrical surface 102, located within the second retaining surface 91, is provided with a diameter 97 dimensioned such that the second constricting element 91 exerts a force on the second securing member 61. Preferably, the force is related to the spring constant of the second constricting element 91.

Adjacent to the third outer cylindrical surface 102 is a fourth outer frusto-conical surface 103. As shown in FIG. 22, the fourth outer frusto-conical surface 103 is at an angle 62 with respect to imaginary line F, which runs perpendicular to the axis Ax of the seal 10. In the preferred embodiment, the angle 62 is 20°.

The fourth outer frusto-conical surface 103 is shaped to retain the second constricting element 91 within the second retaining surface 101. The fourth outer frusto-conical surface 103 is also shaped so that the second constricting element 91 exerts a force in the direction of arrow 92 (shown in FIG. 29), preferably a predetermined force on the second securing member 61. Furthermore, the fourth outer frusto-conical surface 103 is shaped so that the second constricting element 91 is positioned with greater accuracy, such as when the second constricting element 91 is positioned via an automated process.

Referring again to FIG. 29, the fourth outer frusto-conical surface 103 is located on an installation member 104, which is shaped to cooperate with a socket 520. The second installation member 104 is configured to provide greater ease in installing the seal 10 through the action of an installation surface 107 (shown in FIG. 29) configured to expand the diameter 97 (shown in FIG. 32) of the second securing member 61. As shown in FIG. 22 the installation surface 107 is at an angle 108 with respect to imaginary line G, which runs perpendicular to the axis Ax of the seal 10. In the preferred embodiment, the angle 108 is 13°.

The second installation member 104 of the presently preferred embodiment is provided with a plurality of surfaces. As shown in FIG. 29, the second installation member 104 is provided with an outer convex surface 105. The outer convex surface 105 has a cross-sectional shape of an arc of an imaginary circle. As shown in FIG. 29, the imaginary circle is provided with a radius 106 preferably measuring 0.50 cm. While the presently preferred embodiment is shown with a second installation member 104 that provides greater ease in installing the seal 10, in an alternative embodiment, the seal 10 is fabricated without the second installation member 104.

As shown in FIG. 32, the seal 10 of the preferred embodiment is depicted with a first constricting element 72 and a second constricting element 91. According to one aspect of the present invention, the constricting elements 72, 91 are configured to cooperate with the seal 10. According to another aspect, the constricting elements 72, 91 are configured to cooperate with the outer surface 65. According to yet another aspect of the present invention, the constricting elements 72, 91 are configured to cooperate with the inner surface 19.

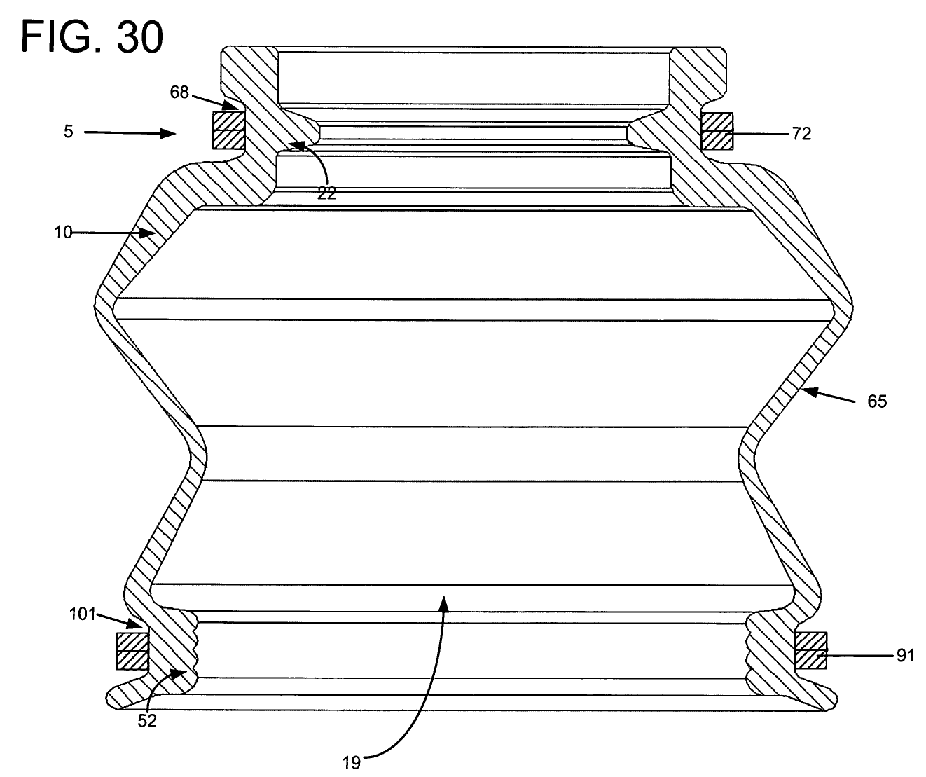

FIG. 32 depicts the constricting elements 72, 91 cooperating with the seal 10. As shown therein, the first constricting element 72 is held in place by the first retaining surface 68 located on the outer surface 65 of the seal 10. FIG. 30 also depicts the second constricting element 91 held in place by the second retaining surface 101 located on the outer surface 65 of the seal 10. The first and second retaining surfaces 65, 91 are shaped so that the constricting elements 72, 91 exert a force upon the securing element 22 and the sealing portion 52, respectively.

As shown in FIG. 32, in the preferred embodiment, the constricting elements 72, 91 exert a force upon the seal 10 in a radially inward direction. As shown therein, in the preferred embodiment, the first constricting element 72 exerts a force upon the securing element 22 such that the securing element 22 is located within the seal acceptor 115. Also shown therein, in the preferred embodiment, the second constricting element 91 exerts a force upon the sealing portion 52 such that the sealing portion 52 is located within a seal acceptor 530. In the preferred embodiment, the first and second constricting elements 72, 91 exert forces according to the spring constants of the constricting elements 72, 91.

The constricting elements 72, 91 are rings fabricated from a plurality of materials. According to one aspect of the present invention, the first and second constricting element 72, 91 is fabricated from a material including a metal, such as steel. According to another aspect of the present invention, the first and second constricting elements 72, 91 are fabricated from a polymer.

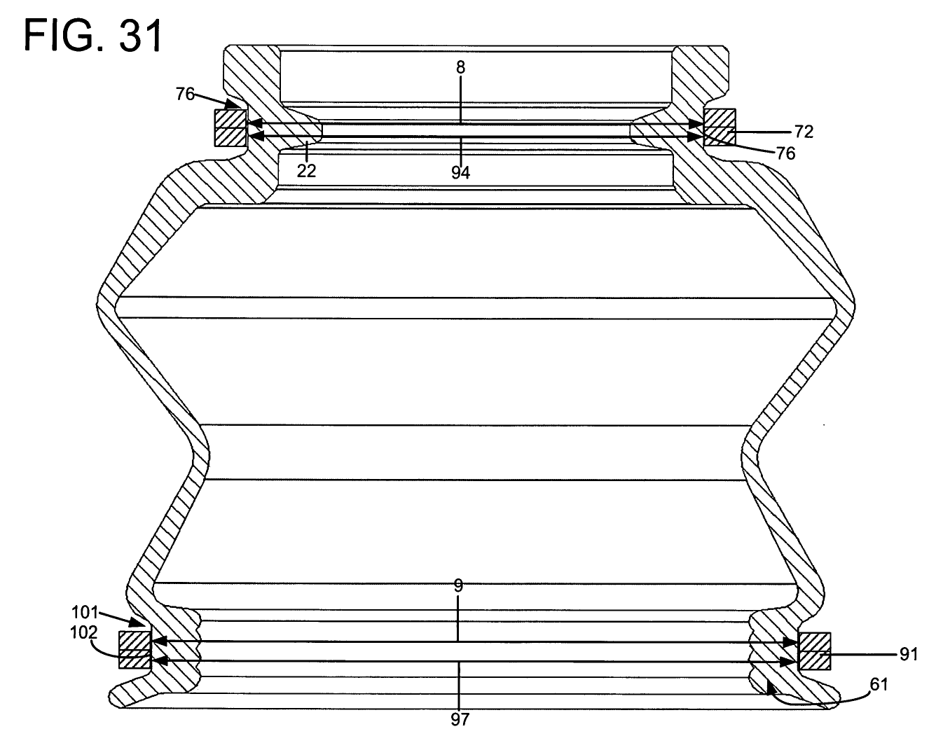

Referring now to FIG. 31, the first constricting element 72 is provided with a diameter 8. The diameter 8 is dimensioned according to the diameter 94 of the second outer cylindrical surface 76. The diameter 8 is preferably smaller than the diameter 94 of the second outer cylindrical surface 76. The second constricting element 91 is provided with a diameter 9 that is dimensioned according to the diameter 97 of the third outer cylindrical surface 102. The diameter 9 is preferably smaller than the diameter 97 of the third outer cylindrical surface 102. Each of the constricting elements 72, 91 resiliently expands during installation so that each constricting element exerts a force on the seal 10 according to the spring constant of the constricting member 71, 91.

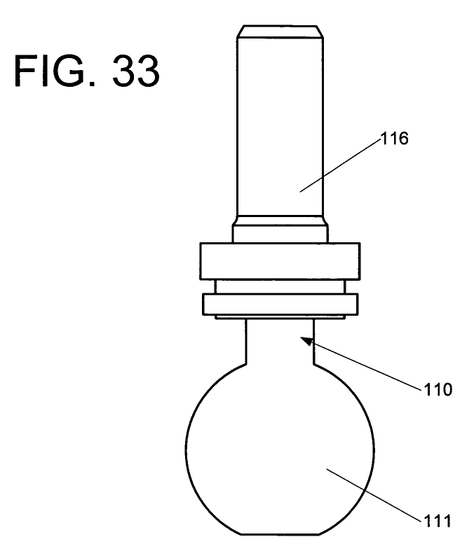

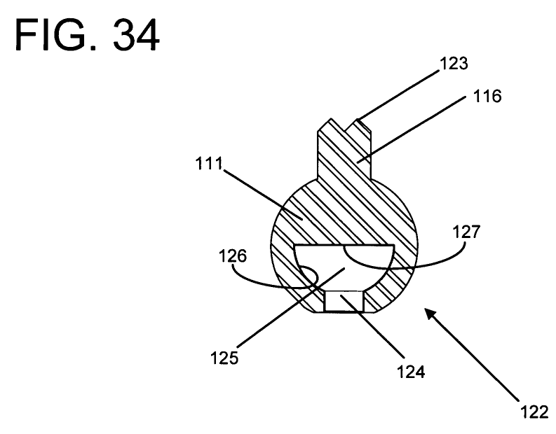

FIG. 33 depicts a ball stud 110 of an alternative embodiment. The ball stud 110 shown in FIG. 33 is fabricated from a plurality of stud elements. The first stud element 122 is depicted in FIG. 34. As depicted therein, the first stud element 122 includes the ball portion 111 and a portion of the shaft 116.

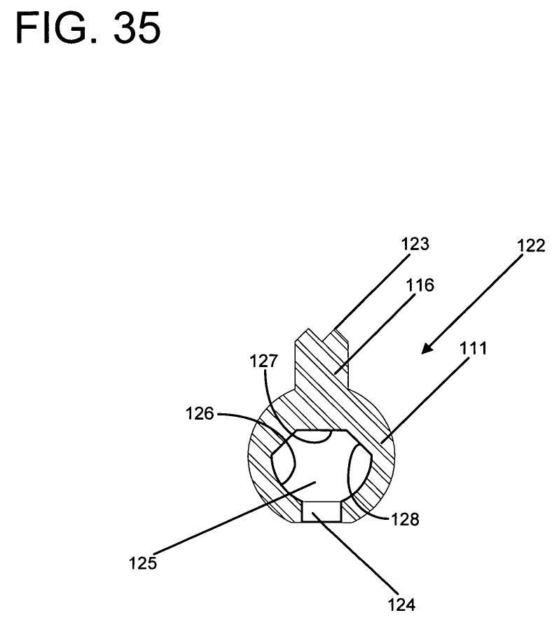

Referring now to FIG. 34, the ball portion 111 defines an opening 124 and is provided with a plurality of inner ball surfaces that define a cavity 125. In the embodiment depicted in FIG. 34, the ball portion 111 is provided with an inner curved surface 125. Located adjacent to the inner curved surface 125 is an inner flat surface 126. Alternatively, as depicted in FIG. 35, an inner conical surface 127 is located adjacent to the inner curved surface 125. The inner conical surface 127 is at an angle, preferably between 0 and 90 degrees relative to the inner flat surface 126 located adjacent to the inner conical surface 127.

The first stud element 122 is fabricated through forging. As used herein, the term “forge,” “forging,” or “forged” is intended to encompass what is known in the art as “cold forming,” “cold heading,” “deep drawing,” and “hot forging.” The first stud element 122 is forged with the use of a National®750 parts former machine. However, other part formers, such as, for example, a Waterbury machine can be used. The process of forging the first stud element 122 begins with a metal wire or metal rod being drawn to size. The ends of the wire or rod are squared off by a punch. After being drawn to size, the wire or rod is run through a series of dies or extrusions. The cavity 125 shown in FIGS. 34 and 35 is extruded through use of a punch and a pin.

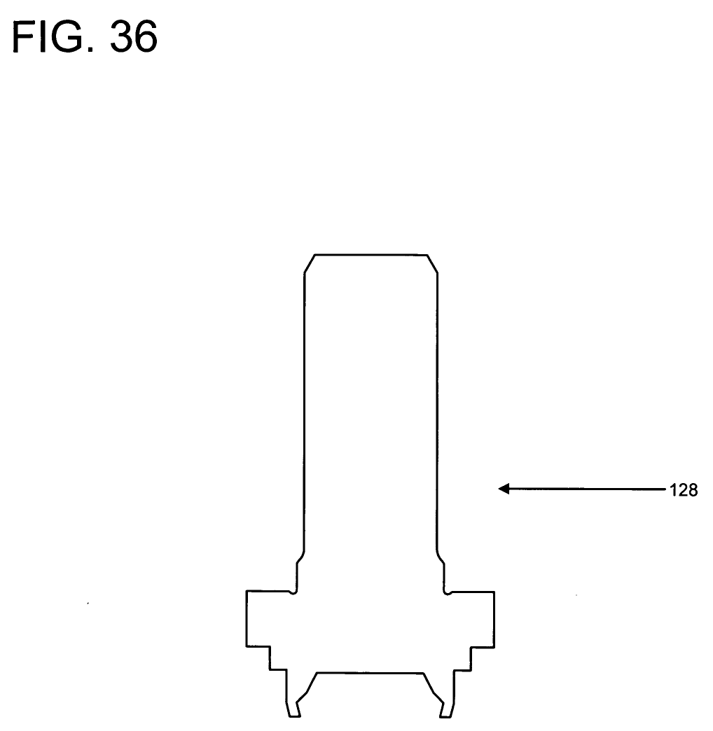

The first stud element 122 is configured for welding. As shown in both FIGS. 34 and 35, the first stud element 122 is provided with a plurality of projections 123. These projections 123 are shaped for welding. The projections 123 shown in FIG. 36 are at an angle of between 35 and 60 degrees relative to the axis of the first stud element (shown as imaginary line F). In the embodiment depicted in FIG. 36, the projections 123 are dimensioned to include a predetermined volume; preferably, the projections 123 include a predetermined volume of welding material.

The first stud element 122 is connected to a second stud element 200 through welding, preferably resistance welding. The projections 123 contact the second stud element 200. High pressure is applied to the area where the projections 123 contact the second stud element 128. After contact, the projections 123 are configured to pass a high current to the through the second stud element 128. Advantageously, the projections 123 are configured to melt and weld together the first stud element 122 and the second stud element 128.

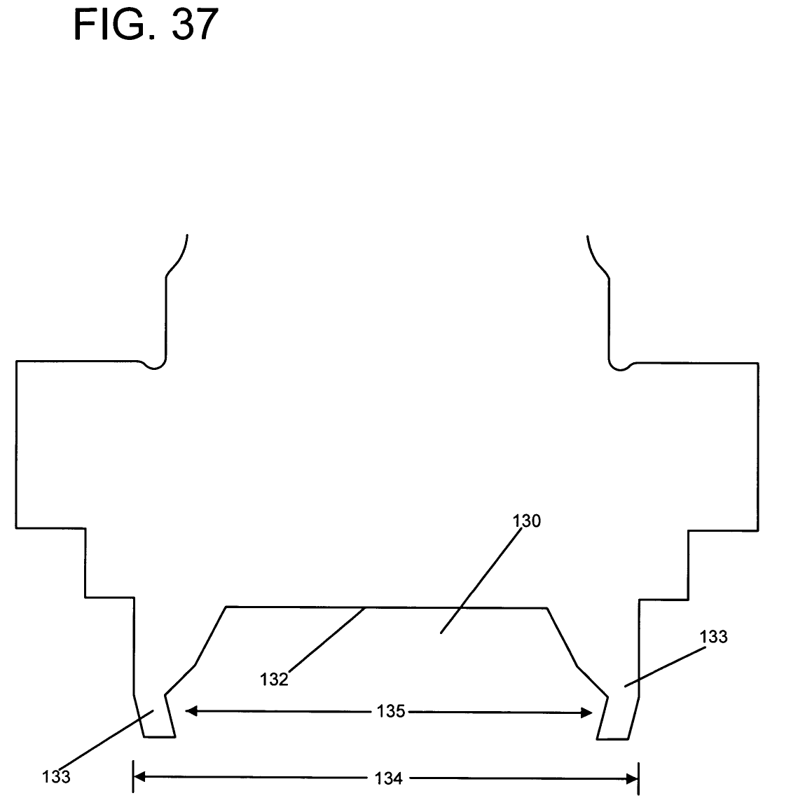

The second stud element 128 is configured to accept the first stud element 122. As depicted in FIG. 37, the second stud element 128 is provided with a coupling surface 129. According to one aspect, the coupling surface 129 is shaped to connect the second stud element 128 to the first stud element 122. According to another aspect, the coupling surface 129 is shaped to connect the second stud element 128 to a third stud element 136.

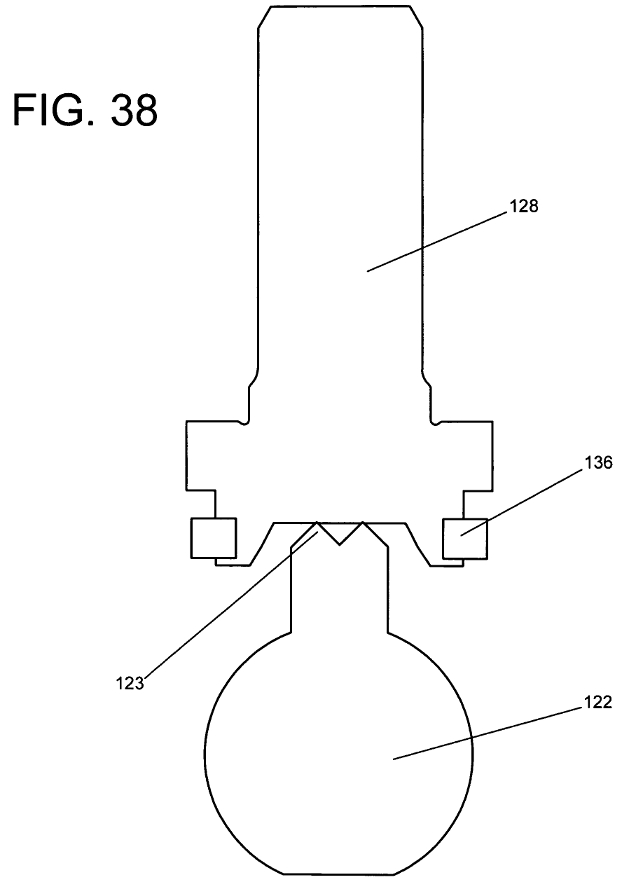

Referring now to FIG. 38, the coupling surface 129 is provided with a plurality of surfaces that define a volume 130. The coupling surface 129 includes a side surface 131 that is conically shaped; however, in an alternative embodiment, the side surface 131 is cylindrically shaped. Located adjacent to the side surface 131 is a flat surface 132. While the preferred embodiment is depicted as having a flat surface 132, in an alternative embodiment, the surface 132 is curved or angled.

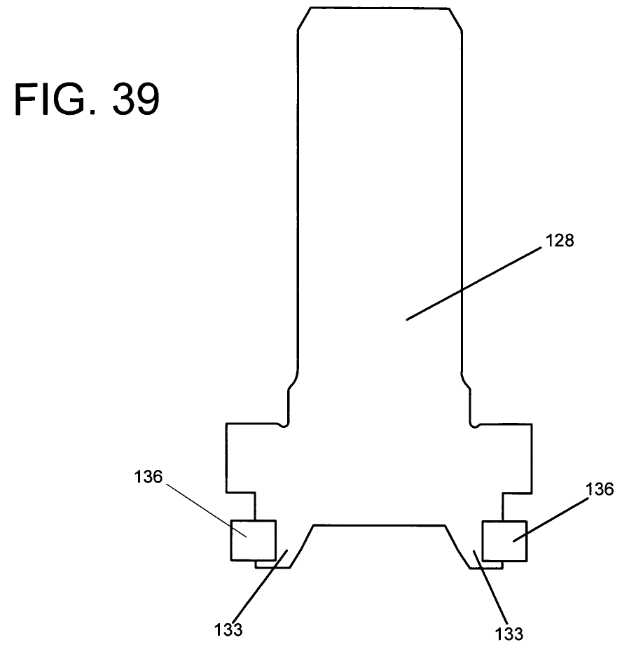

The volume 130 defined by the coupling surface 129 is determined according to the volume of material included in the projections 123 on the first stud element 122. FIG. 39 depicts the second stud element 128 being welded to the first stud element 122. As shown therein, the coupling surface 129 is dimensioned according to the first stud element 122; in the embodiment shown in FIG. 39, the coupling surface 129 is dimensioned to accommodate the projections 123 on the first stud element 122. As depicted, after the projections 123 melt, the volume of material included therein is accommodated within the volume defined by the coupling surface 129.

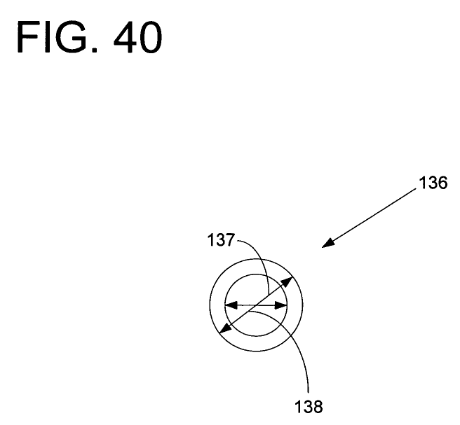

Located adjacent to the coupling surface 129 is a connecting member 133. The connecting member 133 is configured to cooperate with a third stud element 136. Referring now to FIG. 38, the connecting member 133 is shown located adjacent to the coupling surface 129. The connecting member 133 is shaped for ease in positioning the third stud element 136 on the second stud element 128. In FIG. 40, the connecting member 133 is at an angle so that it retains the third stud element 136. Preferably, the connecting member 133 is crimped around at least a portion of the third stud element 136 so that the third stud element 136 is connected to the second stud element 128.

Referring again to FIG. 38, the connecting member 133 is provided with a major diameter 134 and a minor diameter 135. The major and minor diameters 134, 135 are dimensioned so that the connecting member has sufficient strength to be crimped. The major diameter 134 is dimensioned according to the third stud element 136. Preferably, the major diameter 134 of the connecting member 133 is dimensioned according to a minor diameter 137 of the third stud element 136, as shown in FIG. 40.

The third stud element 136 is shown in FIG. 40. According to one aspect, the third stud element 136 is shaped to cooperate with the seal 10. According to another aspect, the third stud element 136 is shaped to cooperate with the second stud element 128. In FIG. 40, the third stud element 136 is annular in shape with a major diameter 138 and a minor diameter 137. The minor diameter 137 is dimensioned according to the second stud element 128. Preferably, the minor diameter 137 is dimensioned so that the connecting member 133 of the second stud element 128 fits within the third stud element 136. The major diameter 138 of the third stud element 136 is dimensioned so that a seal cooperating surface 112 is provided on the ball stud 110.

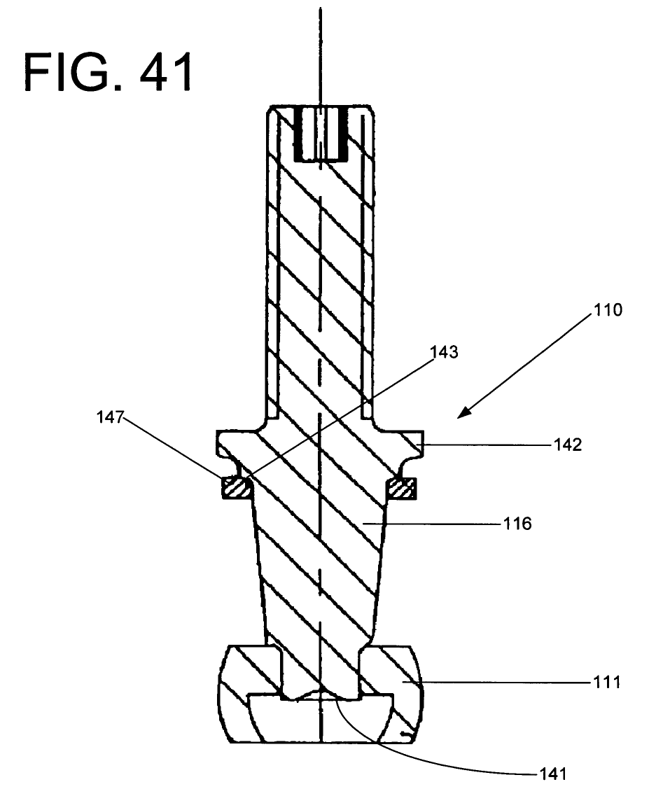

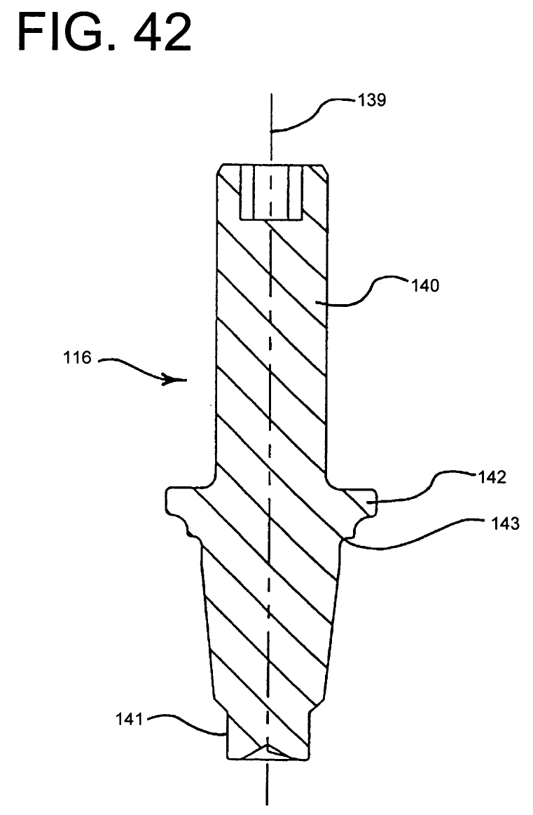

FIG. 41 depicts a ball stud 110 of yet another alternative embodiment. As shown therein, the ball stud 110 includes a ball portion 111 and a shaft 116. FIG. 42 shows a cross-sectional view of the shaft 116 of the ball stud 110. The shaft 116 defines a longitudinal axis 139, a threaded portion 140, and an end portion 141. Intermediate the threaded portion 140 and the end portion 141, the shaft 116 forms an integral raised annular flange 142 that terminates on one side in a shoulder 143. The shaft 116 is preferably formed of a high-strength material such as steel. The ball stud shaft 116 is well suited for fabrication using low cost, high quality, cold-forming processes.

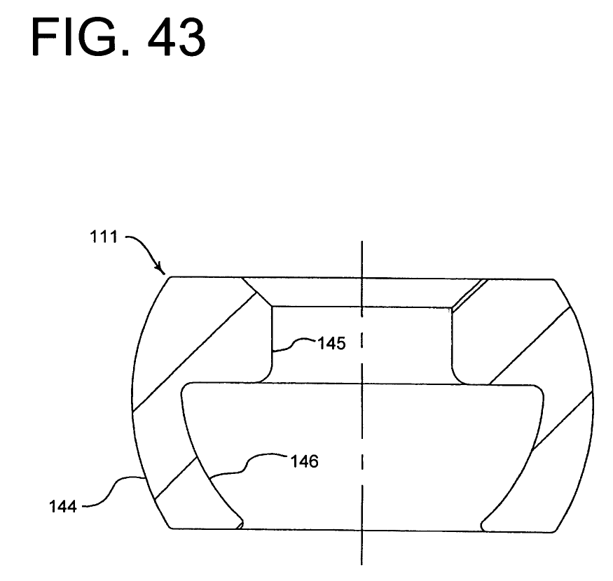

As shown in FIG. 43, the ball stud 110 also includes a ball portion 111 that defines a spherical outer surface 144, a central opening 145 and a recess 146. The recess 146 lightens the ball portion 111, and both ends of the opening 145 are preferably provided with a respective chamfer or radius. As used herein, the term “spherical surface” is intended broadly to encompass surfaces that extend over only a portion of a sphere, such as the outer surface 144.

FIG. 41 shows a cross-sectional view of the ball stud 110 in its assembled condition. The ball stud 110 is assembled by first placing a washer 147 on the shoulder 143 and crimping the shaft 116 to hold the washer 147 in place. This forms a two-part assembly that defines a seal acceptor 115 between the washer 147 and the ridge or flange 142. Next, the ball portion 111 is press fit on the shaft end 141 until the ball portion 111 is firmly seated against the adjacent shoulder of the shaft 116. Then the end portion 141 is upset, as for example with a riveting operation, to secure the ball portion 11 in place.

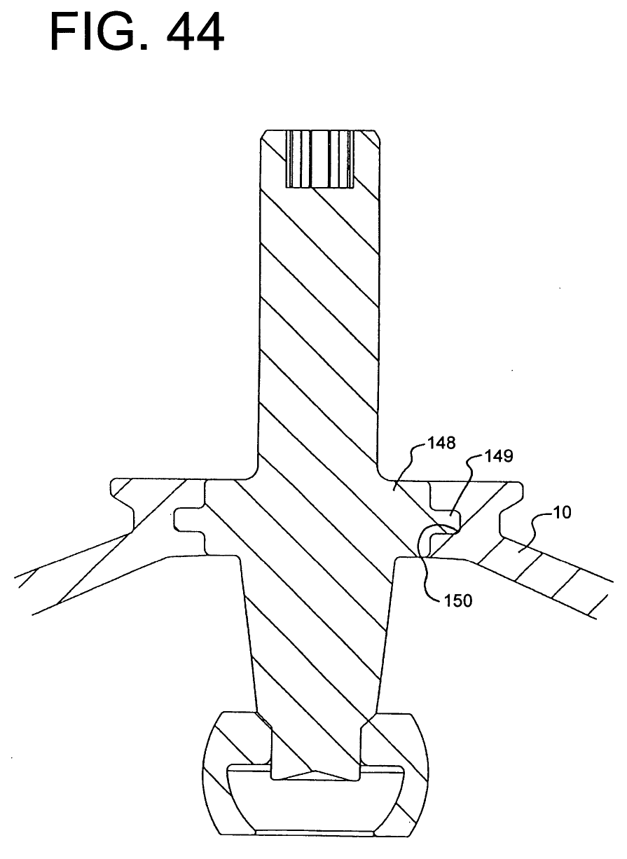

FIG. 44 relates to an alternative embodiment, in which the ball stud 110 includes a flange 148 that defines an annular ridge 149. In this case, the boot 10 defines a shaft acceptor 150 shaped to receive the ridge 149. With this arrangement, only a single flange is required on the ball stud 110, a simplification that reduces manufacturing cost.

While this invention has been particularly shown and described with references to preferred embodiments thereof, it will be understood by those skilled in the art that various changes in form and details may be made therein without departing from the spirit and scope of the invention as defined by the appended claims.

1. A composite link comprising:
a) a coupling member including:
i) a first end provided with an arm;
ii) a composite element that includes a side that is provided with at least one extension that forms the arm on the first end;
iii) a second end;
iv) a stem located between the first and second ends; and
b) an attachment provided with an axis and an outer surface that extends about the axis, wherein the arm wraps at least partially about the outer surface of the attachment and secures the attachment to the coupling member.

2. The composite link according to claim 1, wherein the composite element includes a plurality of unidirectional fibers.

3. The composite link according to claim 1, further comprising a second arm that is located on the first end, wherein the first and second arms wrap at least partially about the outer surface of the attachment, whereby at least a portion of the first and second arms overlap.

4. The composite link according to claim 1, further comprising an inner surface provided on the attachment, wherein a socket of a ball joint is located.

5. The composite link according to claim 1, wherein the coupling member is provided with an inner surface that defines a cavity and a core, a first plug, and a second plug are located within the cavity.

6. The composite link according to claim 1, wherein the composite element includes a plurality of layers.

7. The composite link according to claim 1, further comprising:
a) a retaining surface located on the outer surface of the attachment between a first flange and a second flange;
b) the coupling member includes a priming strip of composite material that is wrapped around the retaining surface; and
c) the arm on the first end wraps at least partially around the priming strip.

8. The composite link according to claim 1, further comprising a crossing element included in the coupling member, wherein the crossing element and composite element include a plurality of unidirectional fibers and the unidirectional fibers of the crossing element are oriented in a different direction than the unidirectional fibers of the composite element.

9. A composite link comprising:
a) a coupling member including:
i) a first end provided with a first arm and a second arm, wherein a slot is defined by the first and second arms;
ii) a second end;
iii) a stem located between the first and second ends; and
b) an attachment occupying at least a portion of the slot and provided with an axis and an outer surface that extends about the axis, wherein the first and second arms wrap at least partially about the outer surface of the attachment.

10. The composite link according to claim 9, further comprising:
a) a retaining surface located on the outer surface of the attachment between a first flange and a second flange;
b) a priming strip of composite material that is wrapped around the retaining surface; and
c) the first and second arms of the first end wrap at least partially around the priming strip, whereby at least a portion of the first and second arms overlap.

11. The composite link according to claim 9, wherein the coupling member is provided with an inner surface that defines a cavity and at least one plug is located within the cavity.

12. The composite link according to claim 9, wherein the coupling member is provided with an inner surface that defines a cavity and a core is located within the cavity.

13. The composite link according to claim 9, wherein at least a portion of the first and second arms overlap.

14. A composite link comprising:
a) a coupling member including:
i) a first end provided with a first arm and a second arm, wherein first and second slots on the first end are defined by the first and second arms;
ii) a second end provided with a first and second arm, wherein first and second slots on the second end are defined by the first and second arms;
iii) a composite element that includes a first side and a second side;
iv) the first side includes a plurality of extension that form the first and second arms on the first end and define a plurality of cutouts on the composite element that form the slot on the first end;
v) the second side includes a plurality of extension that form the first and second arms on the second end and define a plurality of cutouts on the composite element that form the slot on the second end;
vi) a stem located between the first and second ends;
b) a first attachment that occupies at least a portion of the first and second slots on the first end and that includes an axis and an outer surface that extends about the axis, wherein the first and second arms of the first end wrap at least partially about the outer surface of the first attachment; and
c) a second attachment that occupies at least a portion of the first and second slots on the second end and that includes an axis and an outer surface that extends about the axis, wherein the first and second arms of the second end wrap at least partially around the outer surface of the second attachment.

15. The composite link according to claim 14, wherein the outer surfaces of the first attachment and second attachment include a plug that is located within a cavity defined by an inner surface of the coupling member.

16. The composite link according to claim 14, wherein the outer surfaces of the first and second attachments include a retaining surface, a first flange and a second flange, wherein the retaining surface is located between and recessed with respect to the first and second flange.

17. The composite link according to claim 14, wherein:
a) the outer surface of the first and second attachments include a retaining surface that is located between a first flange and a second flange;
b) the coupling member includes a first priming strip of composite material that is wrapped around the retaining surface of the first attachment and a second priming strip of composite material that is wrapped around the retaining surface of the second attachment; and
c) the first and second arms of the first end wrap at least partially around the first priming strip and the first and second arms of the second end wrap at least partially around the second priming strip.

18. The composite link according to claim 14, wherein:
a) the extensions on the first and second sides include a first set of extensions that form the first arms and a second set of extensions that form the second arms; and
b) the cutouts on the first and second sides include a first set of cutouts that form the first slots and a second set of cutouts that form the second slots.

19. The composite link according to claim 14, wherein:
a) a retaining surface is located on the outer surfaces of the first and second attachments between a first flange and a second flange;
b) the coupling member is provided with:
i) an inner surface that defines a cavity wherein a foam core is located;
ii) a first plug fabricated from composite material that is located within the cavity;
iii) a second plug fabricated from composite material that is located within the cavity;
iv) a first priming strip of composite material that is wrapped around the retaining surface on the first attachment,
v) a second priming strip of composite material that is wrapped around the retaining surface on the first attachment;
c) the first and second arms of the first end wrap at least partially around the first priming strip, whereby at least a portion of the first and second arms overlap; and
d) the first and second arms of the second end wrap at least partially around the second priming strip, whereby at least a portion of the first and second arms overlap.

20. The composite link according to claim 14, wherein:
a) a retaining surface is located on the outer surfaces of the first and second attachments between a first flange and a second flange;
b) the coupling member is provided with:
i) a crossing element, wherein the crossing element and composite element include a plurality of unidirectional fibers and the unidirectional fibers of the crossing element are oriented in a different direction than the unidirectional fibers of the composite element;
ii) an inner surface that defines a cavity wherein a foam core is located;
iii) a first plug that is fabricated from a composite material and located within the cavity;
iv) a second plug that is fabricated from a composite material and located within the cavity;
v) a first priming strip of composite material that is wrapped around the retaining surface on the first attachment;
vi) a second priming strip of composite material that is wrapped around the retaining surface on the first attachment;
c) the first and second arms of the first end wrap at least partially around the first priming strip, whereby at least a portion of the first and second arms overlap; and
d) the first and second arms of the second end wrap at least partially around the second priming strip, whereby at least a portion of the first and second arms overlap.
